(19) United States
(12) Patent Application Publication
(10) Pub. No.: US 2025/0042162 A1
(43) Pub. Date: Feb. 6, 2025

(54) LIQUID CARTRIDGE

(71) Applicant: BROTHER KOGYO KABUSHIKI KAISHA, Nagoya (JP)

(72) Inventors: Masahiro HAYASHI, Anjo (JP); Satoru OKI, Nagoya (JP); Yuma TANABE, Nagoya (JP); Naoya OKAZAKI, Hashima (JP)

(73) Assignee: BROTHER KOGYO KABUSHIKI KAISHA, Nagoya (JP)

(21) Appl. No.: 18/788,999

(22) Filed: Jul. 30, 2024

(30) Foreign Application Priority Data
Jul. 31, 2023 (JP) 2023-124424

(51) Int. Cl. B41J 2/175

(52) U.S. Cl. CPC B41J 2/17523; B41J 2/17513; B41J 2/17553; B41J 2/17559; B41J 2/17596

(57) ABSTRACT

A liquid cartridge includes a housing that has a cylindrical portion and a first valve mechanism at least partially accommodated in the cylindrical portion. The housing is blow molded with air blown from an air nozzle. At least a part of an inner surface of the cylindrical portion is a transfer surface to which an outer peripheral surface of a mold is transferred.

### REFERENCE TO RELATED APPLICATIONS

This application claims priority from Japanese Patent Application No. 2023-124424 filed on Jul. 31, 2023. The entire content of the priority application is incorporated herein by reference.

### BACKGROUND ART

An ink refilling container in which ink is stored is known. A housing of the ink refilling container is formed by a blow-molded outer wall and a lid member. The lid member includes an ink supply port and a check valve provided in the ink supply port. The check valve closes the ink supply port.

### SUMMARY

A liquid cartridge includes a housing that has a cylindrical portion and a first valve mechanism at least partially accommodated in the cylindrical portion. The housing is blow molded with air blown from an air nozzle. At least a part of an inner surface of the cylindrical portion is a transfer surface to which an outer peripheral surface of a mold is transferred.

### BRIEF DESCRIPTION OF THE DRAWINGS

FIG. 1 is a longitudinal sectional view schematically showing an internal structure of a printer 10.

FIG. 2 is a rear perspective view of a cartridge case 110.

FIG. 3 is a perspective view of an ink cartridge 30 as viewed from the front and above.

FIG. 4 is a perspective view of the ink cartridge 30 as viewed from the rear and below.

FIG. 5 is a right side view of the ink cartridge 30.

FIG. 6 is a plan view of the ink cartridge 30.

FIG. 7 is a bottom view of the ink cartridge 30.

FIG. 8 is a front view of the ink cartridge 30.

FIG. 9 is a rear view of the ink cartridge 30.

FIG. 10 is a left side view of the ink cartridge 30.

FIG. 11 is a front view of four ink cartridges 30.

FIG. 12 is a partial cross-sectional perspective view of the ink cartridge 30 and the cartridge case 110, showing a state where the ink cartridge 30 is being inserted into the cartridge case 110.

FIGS. 13A and 13B are cross-sectional views of the ink cartridge 30 and the cartridge case 110, each showing a state where the ink cartridge 30 is positioned in the cartridge case 110 and an ink receiving member 130 is positioned at a first position.

FIG. 13A is a cross-sectional view of the ink cartridge 30 and the cartridge case 110, taken along a vertical plane intersecting a lower surface 70 of the ink cartridge 30.

FIG. 13B is a cross-sectional view of the ink cartridge 30 and the cartridge case 110, taken along a vertical plane intersecting a first key portion 77 of the ink cartridge 30.

FIGS. 14A and 14B are cross-sectional views of the ink cartridge 30 and the cartridge case 110, each showing a state in which the ink cartridge 30 is positioned in the cartridge case 110 and the ink receiving member 130 is in a second position.

FIG. 14A is a cross-sectional view of the ink cartridge 30 and the cartridge case 110, taken along a vertical plane intersecting a lower surface 70 of the ink cartridge 30.

FIG. 14B is a cross-sectional view of the ink cartridge 30 and the cartridge case 110, taken along a vertical plane intersecting a first key portion 77 of the ink cartridge 30.

FIGS. 15A and 15B are cross-sectional views of the ink cartridge 30 and the cartridge case 110, each showing a state where the ink cartridge 30 is positioned in the cartridge case 110 and a supply tube 102 is inserted into a supply port 34.

FIG. 15A is a cross-sectional view of the ink cartridge 30 and the cartridge case 110, taken along a vertical plane intersecting a lower surface 70 of the ink cartridge 30.

FIG. 15B is a cross-sectional view of the ink cartridge 30 and the cartridge case 110, taken along a vertical plane intersecting a first key portion 77 of the ink cartridge 30.

FIGS. 16A and 16B are cross-sectional views of the ink cartridge 30 and the cartridge case 110, each showing an attached state of the ink cartridge 30 where the ink cartridge 30 is attached to the cartridge case 110.

FIG. 16A is a cross-sectional view of the ink cartridge 30 and the cartridge case 110, taken along a vertical plane intersecting a lower surface 70 of the ink cartridge 30.

FIG. 16B is a cross-sectional view of the ink cartridge 30 and the cartridge case 110, taken along a vertical plane intersecting a first key portion 77 of the ink cartridge 30.

FIG. 17 is a partial cross-sectional perspective view of the ink cartridge 30 and the cartridge case 110, showing the attached state of the ink cartridge 30 where the ink cartridge 30 is attached to the cartridge case 110.

FIG. 18 is a right side view of an ink cartridge 30 according to a modification.

FIG. 19 is a right side view of an ink cartridge 30 according to another modification.

FIG. 20 is a rear view of an ink cartridge 30 according to a further modification.

FIG. 21 is a perspective view of an ink cartridge 30 according to a yet further modification as viewed from the front and above.

FIG. 22 is an enlarged view of a periphery including the supply portion 33 in FIG. 13.

FIG. 23 is a perspective view of an upper support member 38.

FIGS. 24A and 24B are views showing manufacturing processes of a container body 31.

### DESCRIPTION

For example, in a housing of an ink refilling container, a lid member having an ink supply port is formed separately from an outer wall, so that the dimensional accuracy of the ink supply port is maintained, and the sealing function by the check valve is exhibited. If the ink supply port is formed by blow molding, ink leakage may occur due to poor dimensional accuracy.

The present disclosure provides a liquid cartridge in which liquid is unlikely to leak from the liquid cartridge including a blow-molded housing.

(1) The present disclosure relates to a liquid cartridge. The liquid cartridge includes a housing that has a cylindrical portion; and a first valve mechanism at least partially accommodated in the cylindrical portion. The housing is blow molded with air blown from an air nozzle. At least a part of an inner surface of the cylindrical portion is a transfer surface to which an outer peripheral surface of a mold is transferred. The first valve mechanism includes; a seal member that defines a first through hole and is in contact with the transfer surface; a valve positioned in the cylindrical portion and configured to open and close the first through hole; and a biasing member configured to bias the valve toward the seal member. The seal member includes a first seal portion in contact with the transfer surface and a second seal portion configured to contact with the valve.

Since the housing is blow molded and integrally formed, the number of components is reduced. The transfer surface with which the first seal portion is in contact is a portion to which the outer peripheral surface of the mold is transferred, thus has a small dimensional error. Therefore, a gap due to a dimensional error is unlikely to be formed between the first seal portion and the transfer surface of the cylindrical portion, and thus the liquid in the liquid cartridge is unlikely to leak to the outside through the gap between the first seal portion and the transfer surface of the cylindrical portion. Since the first seal portion is in contact with the transfer surface of the cylindrical portion having a small dimensional error, the position of the seal member with respect to the valve is unlikely to be displaced. Therefore, a gap is unlikely to be formed between the second seal portion and the valve in a state where the second seal portion is in contact with the valve. Therefore, in a state where the valve closes the first through hole, the liquid in the liquid cartridge is unlikely to leak to the outside through a gap between the second seal portion and the valve.

(2) The outer peripheral surface of the mold is an outer peripheral surface of the air nozzle.

When the housing is blow molded, the transfer surface is molded by using the outer peripheral surface of the air nozzle, and thus the housing can be molded more quickly than in a case where a mold for molding the transfer surface is used separately from the air nozzle.

(3) The liquid cartridge further includes a support member that has a cylindrical shape, is accommodated in the cylindrical portion, and accommodates the valve and the biasing member therein. The support member includes a contact portion in contact with the seal member.

The contact portion is in contact with the seal member, whereby the position of the seal member can be determined. The position of the seal member is determined at an accurate position, and thus the seal member can easily be brought into contact with the transfer surface. The valve and the biasing member are likely to be maintained in a stable posture in the support member.

(4) The cylindrical portion that extends in a first direction. The contact portion is in contact with the seal member in one direction in the first direction.

Since the position of the seal member is determined in the first direction in which the cylindrical portion extends, the seal member can easily be brought into contact with the transfer surface of the cylindrical portion to which the outer peripheral surface of the air nozzle is transferred.

(5) The seal member includes a first portion having the first seal portion, and a second portion having the second seal portion and extending form the first portion in an other direction opposite to the one direction.

The position of the seal member is determined in the intersecting direction intersecting the first direction by the contact portion contacting the outer peripheral surface of the second portion, and therefore the position of the seal member with respect to the valve is unlikely to shift in the intersecting direction.

(6) The first valve mechanism defines a second through hole and includes a contact member in contact with the seal member. The contact member is in contact with an inner peripheral surface of the first portion.

The contact member is in contact with the inner peripheral surface of the first portion, and thus the position of the seal member is more reliably determined in the intersecting direction intersecting the first direction and is less likely to fall off from the cylindrical portion.

(7) The first valve mechanism defines a second through hole and includes a contact member in contact with the seal member.

The position of the seal member is more reliably determined by being brought into contact with the contact member, and is less likely to fall off from the cylindrical portion.

(8) The contact member is in contact with the seal member in an other direction opposite to the one direction.

The position of the seal member is more reliably determined in the first direction.

(9) The seal member has a first portion having the first seal portion. The contact member is in contact with an inner peripheral surface of the first portion.

Since the position of the seal member is determined in the intersecting direction intersecting the first direction by the cap, the first sealing portion is easily held in a state in contact with the transfer surface of the cylindrical portion to which the outer peripheral surface of the air nozzle is transferred.

(10) The contact member is bonded or welded to the transfer surface.

The contact member is bonded or welded to the transfer surface having a small dimensional error, and therefore is firmly fixed to the inner surface of the cylindrical portion.

(11) At least a part of the inner peripheral surface of the support member is a first guide surface configured to guide the biasing member in a first direction in which the cylindrical portion extends.

The biasing member is guided by the first guide surface in the first direction, and therefore the posture of the biasing member is less likely to be inclined.

(12) At least a part of the inner peripheral surface of the support member is a second guide surface configured to guide the valve in the first direction in which the cylindrical portion extends.

The valve is guided by the second guide surface in the first direction, and therefore the posture of the valve is less likely to be inclined.

(13) The second guide surface is a single surface in the first direction.

Since the second guide surface has no gap, the valve can be moved more smoothly.

(14) The support member is in pressure contact with at least a part of the inner surface of the cylindrical portion.

Since the posture of the support member is less likely to be inclined, the position of the seal member can be more reliably determined.

(15) The cylindrical portion has a tapered surface that defines an internal space such that the internal space gradually narrows in an other direction opposite to one direction in a first direction in which the cylindrical portion extends. The support member is in contact with the tapered surface.

The support member is in contact with the tapered surface in a direction opposite to the one direction in the first direction. Therefore, the position of the support member is more reliably determined in the first direction. Therefore, the seal member can be more reliably brought into contact with the transfer surface of the cylindrical portion.

(16) The valve includes a first valve configured to contact with the first portion and a second valve configured to contact with the second portion.

Since the second seal portion is provided at two positions, i.e., the position where the first portion contacts with the first valve and the position where the second portion contacts with the second valve, the liquid in the liquid cartridge is less likely to leak to the outside through the gap between the second seal portion and the valve.

(17) The housing includes a chamber configured to store liquid therein and an atmosphere communication port configured to communicate with the chamber and an outside.

When the first through hole of the seal member is opened and the liquid in the liquid cartridge flows out to the outside through the first through hole, air flows into the liquid cartridge through the atmosphere communication port, and therefore the liquid in the liquid cartridge easily moves to the outside.

(18) The housing includes a semipermeable membrane that closes the atmosphere communication port, blocks passage of liquid, and allows passage of air.

The liquid is less likely to leak from the atmosphere communication port.

(19) The liquid cartridge further includes a second valve mechanism configured to open and close the atmosphere communication port.

The liquid is less likely to leak from the atmosphere communication port.

(20) The housing includes a chamber configured to store liquid therein and a protrusion that protrudes from an outer surface of the housing. An internal space of the protrusion communicates with the chamber.

Since the protrusion can be easily integrally formed in the housing by blow molding, the volume of the chamber can be easily increased.

According to the present invention, the liquid is less likely to leak from the liquid cartridge including the blow molded housing.

Hereinafter, embodiments of the present disclosure will be described with reference to the drawings as appropriate.

In the following, an ink cartridge 30 is inserted into and removed from a cartridge case 110 in a horizontal direction (a direction orthogonal to the gravity direction). Further, whenever appropriate, a frontward direction and a rearward direction may be collectively referred to as a front-rear direction. An upward direction and a downward direction may be collectively referred to as an up-down direction. A rightward direction and a leftward direction may be collectively referred to as a right-left direction. The description will be made on the assumption that the front-rear direction and the right-left direction are horizontal directions. Further, a vertical direction orthogonal to the front-rear direction is defined as the up-down direction. A direction orthogonal to the up-down direction and the front-rear direction is defined as the right-left direction. The front-rear direction is also referred to as a first direction. Note that an attached state in which the ink cartridge 30 is attached to the cartridge case 110 is a state in which the ink cartridge 30 has been inserted to an attachment position in the cartridge case 110 and is ready to be used with the printer 10. The attachment position is a position at which a supply tube 102 provided in the cartridge case 110 is inserted into a supply port 34 provided in the ink cartridge 30 and is connected to the supply port 34.

Hereinafter, the posture of the ink cartridge 30 when the ink cartridge 30 is in the attached state and is ready to be used with the printer 10 is referred to as a usage posture or an upright posture. Unless otherwise specified, when the positional relations between the components of the ink cartridge 30 are described with the terms “up”, “down”, “left”, “right”, “front”, and “rear” and when the orientations or directions of the components of the ink cartridge 30 are described with the terms “up”, “down”, “left”, “right”, “front”, and “rear”, such descriptions are made based on when the ink cartridge 30 is in the usage posture. Moreover, when the positions, orientations or directions of the ink cartridge 30 itself is described with the terms “up”, “down”, “left”, “right”, “front”, and “rear”, such descriptions are made based on when the ink cartridge 30 is in the usage posture. The ink cartridge 30 is inserted into the cartridge case 110 in the frontward direction, which direction may be referred to as an attachment direction or one direction. The ink cartridge 30 is removed from the cartridge case 110 in the rearward direction. The rearward direction may be referred to as a reverse direction. When it is described that a component of the ink cartridge 30 faces a certain direction, the direction in which the component faces is not strictly limited to that certain direction only. For example, when it is described that “a front surface faces frontward”, the front surface may face frontward and upward.

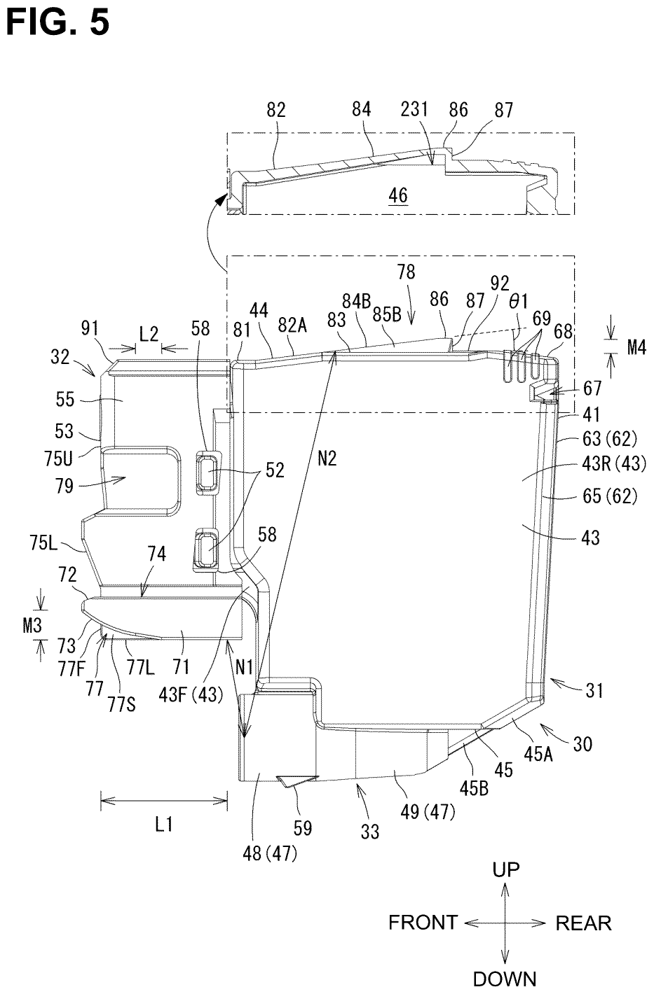

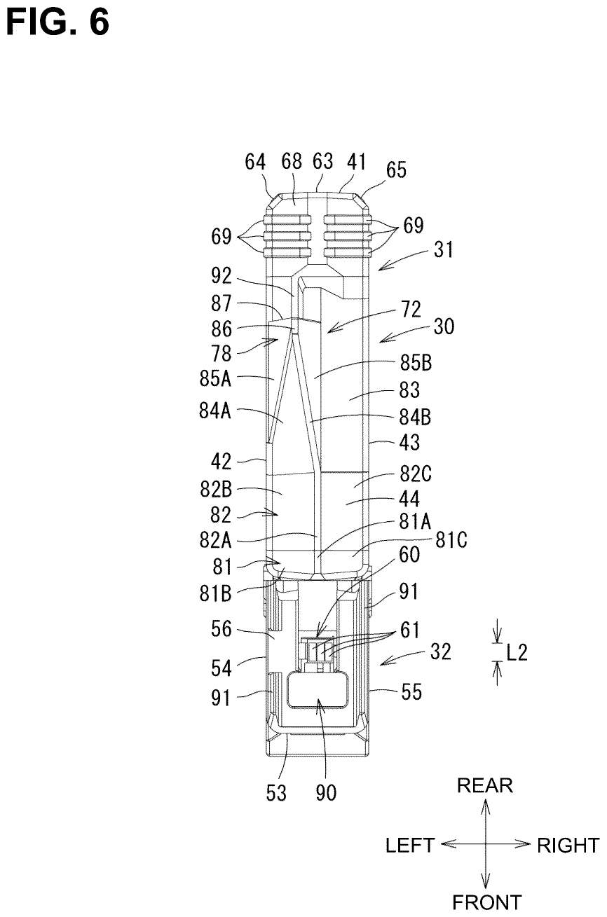

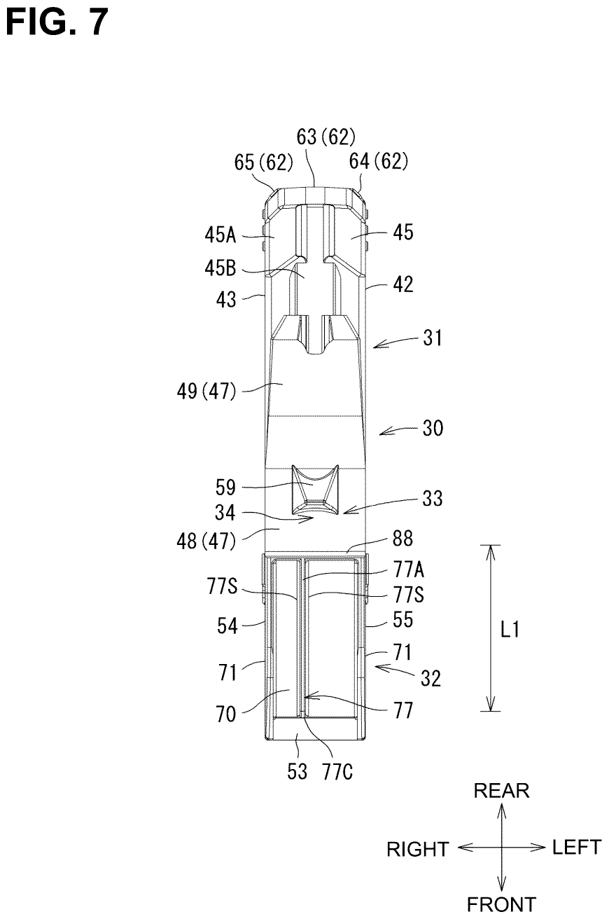

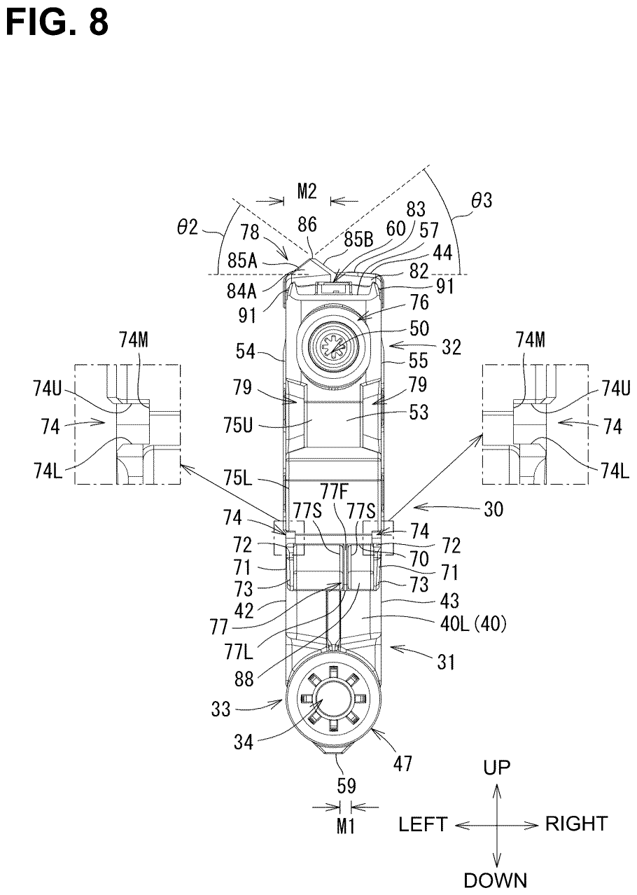

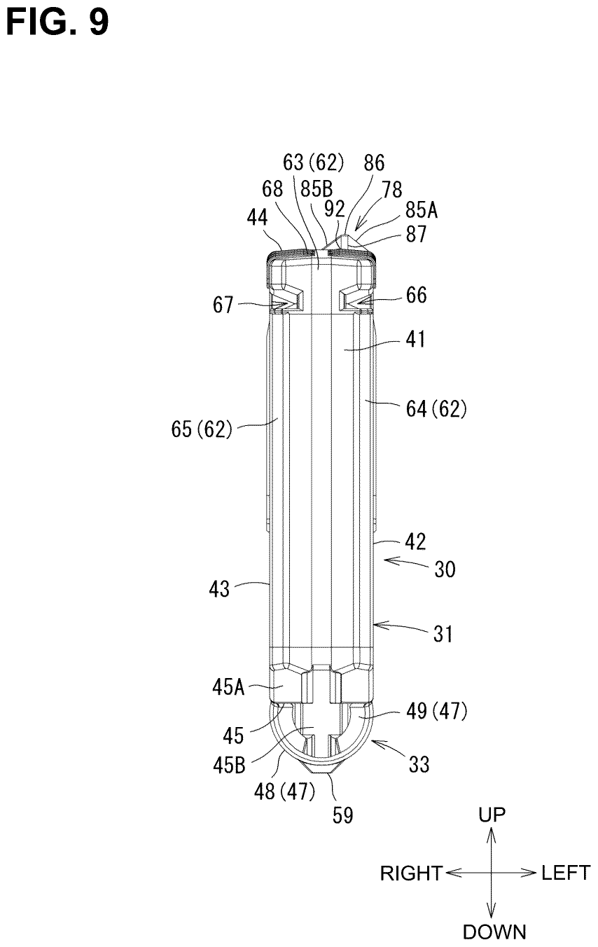

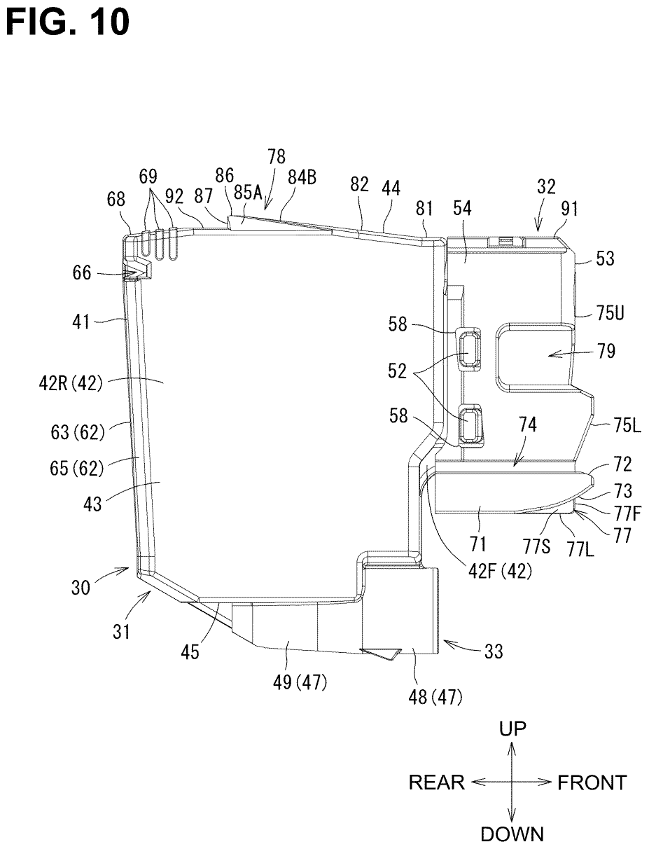

A front surface of the ink cartridge 30 is a surface appearing in the front view shown in FIG. 8. A rear surface of the ink cartridge 30 is a surface appearing in the rear view shown in FIG. 9. An upper surface of the ink cartridge 30 is a surface appearing in the plan view shown in FIG. 6. A lower surface of the ink cartridge 30 is a surface appearing in the bottom view shown in FIG. 7. A left surface of the ink cartridge 30 is a surface appearing in the left side view shown FIG. 10. A right surface of the ink cartridge 30 is a surface appearing in the right side view shown in FIG. 5.

### [Outline of Printer 10]

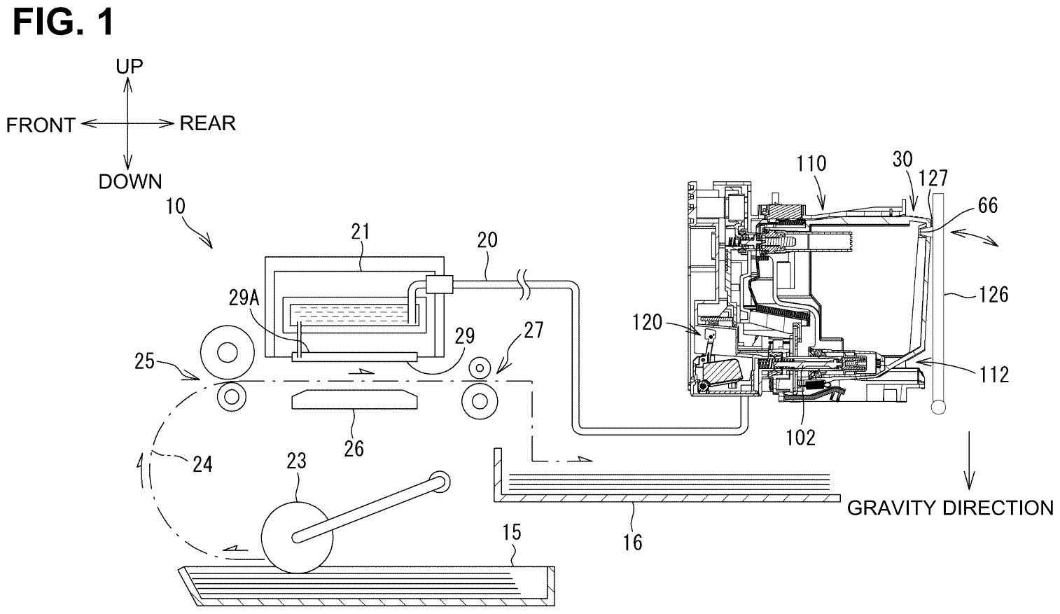

As shown in FIG. 1, the printer 10 includes the cartridge case 110, a sub-tank 120, an ink tube 20, a recording head 21, and the ink cartridge 30. The printer 10 is an inkjet recording apparatus, for example, an inkjet printer that records an image by ejecting ink droplets from the recording head 21 onto a sheet on the basis of an inkjet recording method. The printer 10 includes the cartridge case 110. The ink cartridge 30 is configured to be attached to the cartridge case 110. The ink cartridge 30 is an example of a liquid cartridge. The cartridge case 110 has an opening 112 at its rear end. The ink cartridge 30 is configured to be inserted frontward into the case 110 through the opening 112 and to be attached to the case 110 when the ink cartridge 30 reaches the attachment position. The ink cartridge 30 is configured to be detached and removed rearward from the case 110 through the opening 112. The opening 112 is covered by a cover 126 when the cover 126 is closed and is exposed to the outside of printer 10 when the cover 126 is opened. FIG. 1 shows a state in which the ink cartridge 30 is completely attached to the cartridge case 110. That is, FIG. 1 shows the ink cartridge 30 in the attached state. The posture of the ink cartridge 30 in the attached state is the usage posture.

The ink cartridge 30 stores ink that can be used in the printer 10. The ink may be a liquid containing a coloring material such as a pigment or a processing liquid not containing a coloring material, but containing an additive for improving the quality of image formed by the coloring material. In a state where the ink cartridge 30 is completely attached to the cartridge case 110, that is, when the ink cartridge 30 is in the attached state, the ink cartridge 30 and the recording head 21 are connected to each other via the ink tube 20. The recording head 21 discharges the ink supplied from the ink cartridge 30 from a plurality of nozzles 29. Specifically, a head control board included in the recording head 21 selectively applies a driving voltage to a plurality of piezoelectric elements 29A provided corresponding to the plurality of nozzles 29. As a result, ink is selectively ejected from the nozzles 29. That is, the recording head 21 consumes the ink stored in the ink cartridge 30 attached to the cartridge case 110.

The printer 10 includes a paper feed tray 15, a paper feed roller 23, a pair of conveyance rollers 25, a platen 26, a pair of discharge rollers 27, and a paper discharge tray 16. The paper feed roller 23 feeds a sheet on the paper feed tray 15 toward the conveyance path 24. The sheet fed to the conveyance path 24 reaches the pair of conveyance rollers 25. The pair of conveyance rollers 25 conveys the sheet that has reached the pair of conveyance rollers 25 onto the platen 26. The recording head 21 selectively ejects ink onto the sheet passing over the platen 26. Thus, an image is recorded on the sheet. The sheet having passed through the platen 26 reaches the pair of discharge rollers 27. The pair of discharge rollers 27 discharges the sheet that has reached the pair of discharge rollers 27 to the discharge tray 16 positioned at the most downstream end of the conveyance path 24.

### [Cartridge Case 110]

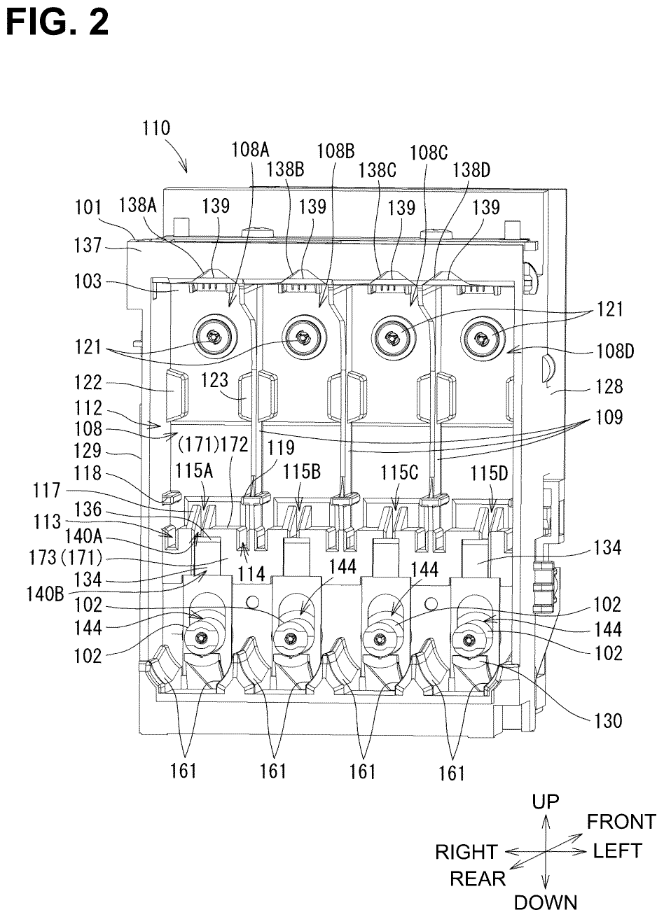

As shown in FIG. 2, the cartridge case 110 includes a case body 101 and a supply tube 102.

The case body 101 has a box shape. The case body 101 has an internal space to which the ink cartridge 30 is attached. The case body 101 has an end surface 103 that defines a front end in the attachment direction when the ink cartridge 30 is attached to the internal space, a left wall that defines a left end of the internal space, a right wall that defines a right end of the internal space, a lower wall, and a cover wall 171 that covers a pressing plate 134 described later. The cover wall 171 includes an upper wall 172 facing upward and a rear wall 173 extending downward from a rear end portion of the upper wall 172. The case body 101 has the opening 112 at its rear end. When the user opens the cover 126 to use the printer 10, the opening 112 is exposed.

The case body 101 has three partition walls 109 in its internal space. The three partition walls 109 are arranged at intervals in the left-right direction. The internal space of the case body 101 has four slots 108A, 108B, 108C, and 108D arranged in the left-right direction. The slot 108A is positioned on the rightmost side among the four slots 108A to 108D. The slot 108B is positioned to the left of the slot 108A. The slot 108C is positioned to the left of the slot 108B. The slot 108D is positioned on the left of the slot 108C and on the leftmost side among the four slots 108A to 108D. The internal space of the case body 101 is partitioned into slots 108A, 108B, 108C, and 108D by three partition walls 109 that partition the internal space of the case body 101 and by the inner surface of the case body 101.

The partition wall 109 extends upward from the upper surface of the upper wall 172 of the cover wall 171. Three partition walls 109 are positioned at equal intervals in the left-right direction. The partition wall 109 has a flat plate shape extending in the up-down direction and the left-right direction. The partition wall 109 extends from the front end to the rear end of the upper wall 172.

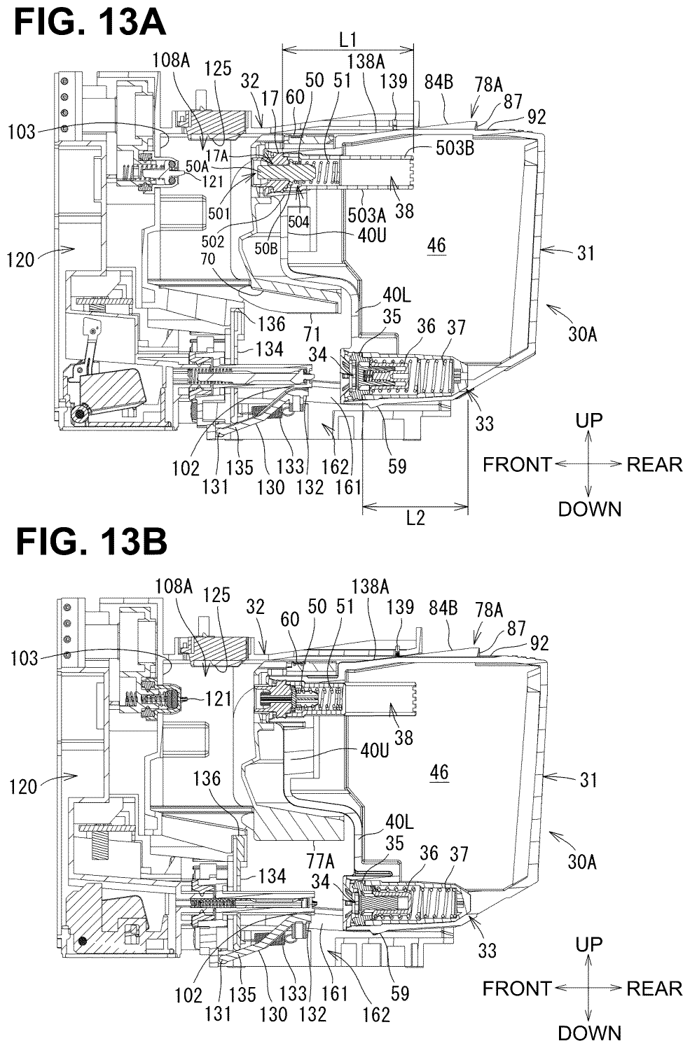

The case body 101 has a guide surface 161. The guide surface 161 is arranged in each of the slots 108A, 108B, 108C, and 108D. The guide surface 161 faces upward. The guide surface 161 is generally a semi-peripheral surface. When the ink cartridge 30 is attached to or detached from the case body 101, the guide surface 161 guides the ink cartridge 30 in the front-rear direction. The guide surface 161 supports the lower end of the ink cartridge 30 in the attached state where the ink cartridge 30 is attached to the case body 101. As shown in FIGS. 13A and 13B, a space 162 exists below the supply tube 102.

As shown in FIG. 2, the cover wall 171 is positioned below the end surface 103 of the case body 101. The upper wall 172 has a flat plate shape extending in the front-rear direction and the left-right direction. The upper wall 172 extends from the left wall to the right wall of the case body 101. The rear wall 173 has a flat plate shape extending in the up-down direction and the left-right direction. The rear wall 173 extends from the left wall to the right wall of the case body 101. In the rear wall 173, through holes 144 are positioned at equal intervals in the left-right direction in the respective slots 108A, 108B, 108C, and 108D. The guide surface 161 is positioned below the through hole 144. The supply tube 102 passes through the through hole 144 and protrudes rearward from the rear wall 173.

In each slot 108A, 108B, 108C, and 108D, the top wall 172 has a groove 113 and a groove 114. The groove 113 and the groove 114 in each of the slots 108A, 108B, 108C, and 108D have a common shape. The groove 113 is positioned at the left end of each of the slots 108A, 108B, 108C, and 108D, and the groove 114 is positioned at the right end of each of the slots 108A, 108B, 108C, and 108D. Both the groove 113 and the groove 114 are recessed downward from the upper wall 172 and extend along the front-rear direction so as to be open in the rear wall 173. The ink cartridge 30 includes a pair of walls 71 (described later) and each wall 71 is inserted into the corresponding one of the groove 113 and the groove 114.

In each of the slots 108A, 108B, 108C, and 108D, two protruding pieces 117 protruding upward from the upper wall 172 of the cover wall 171 and spaced apart from each other in the left-right direction are provided between the groove 113 and the groove 114 in the left-right direction. The upper wall 172 of the cover wall 171 has a through hole 140A that is continuous with a space between the two protruding pieces 117. The rear wall 173 of the cover wall 171 has a through hole 140B. The lower end of the through hole 140A and the upper end of the through hole 140B are continuous with each other. A first key slot 115 is positioned between the two protruding pieces 117 in each of the slots 108A, 108B, 108C, and 108D. Specifically, the slot 108A has a first key slot 115A, the slot 108B has a first key slot 115B, the slot 108C has a first key slot 115C, and the slot 108D has a first key slot 115D. The first key slot 115 opens upward and rearward. A first key portion 77 (described later) of the ink cartridge 30 is insertable into the first key slot 115.

The first key slots 115A, 115B, 115C, and 115D have different positions in the left-right direction with respect to the groove 113 and the groove 114. Specifically, the first key slot 115A is closer to the groove 113 than the center of the slot 108A between the groove 113 and the groove 114 in the left-right direction. The first key slot 115B is closer to the groove 114 in the slot 108B than the first key slot 115A is to the groove 114 in the slot 108A in the left-right direction. The first key slot 115C is closer to the groove 114 in the slot 108C than the first key slot 115B is to the groove 114 in the slot 108B in the left-right direction. The first key slot 115D is closer to the groove 114 in the slot 108D than the first key slot 115C is to the groove 114 in the slot 108C in the left-right direction.

In each slot 108A, 108B, 108C, and 108D, a rib 118 is positioned above the groove 113 and a rib 119 is positioned above the groove 114. At the slot 108A, the rib 118 protrudes from the inner surface of the right wall 129. At the slot 108B, the rib 118 protrudes from the partition wall 109 defining the right end of the slot 108B. At the slot 108C, the rib 118 protrudes from the partition wall 109 defining the right end of the slot 108C. At the slot 108D, the rib 118 protrudes from the partition wall 109 defining the right end of the slot 108C. At the slot 108A, the rib 119 protrudes from the partition wall 109 defining the left end of the slot 108A. At the slot 108B, the rib 119 protrudes from the partition wall 109 defining the left end of the slot 108B. At the slot 108C, the rib 119 protrudes from the partition wall 109 defining the left end of the slot 108C. At the slot 108D, the rib 119 protrudes from the inner surface of the left wall 128. The ribs 118 and 119 face each other in the left-right direction in each of the slots 108A, 108B, 108C, and 108D.

The supply tube 102 is positioned in the internal space of each of the slots 108A, 108B, 108C, and 108D. The supply tube 102 is positioned below each of the first key slots 115A, 115B, 115C, and 115D. The supply tube 102 has a hollow circular pipe shape. The supply tube 102 extends along the front-rear direction from a sub-tank 120 toward the internal space of each of the slots 108A, 108B, 108C, and 108D. A rear end of the supply tube 102 is opened. The rear end of the supply tube 102 is positioned in the inner space of each of the slots 108A, 108B, 108C, and 108D. Although not described in detail, a valve 102A is disposed in the inner space of the supply tube 102. The valve 102A opens and closes an opening 207 of the supply tube 102. The supply tube 102 is connectable to the supply port 34 of the ink cartridge 30.

As shown in FIG. 1, a front end of the supply tube 102 is connected to the sub-tank 120. The sub-tank 120 has a space that stores the ink supplied from the ink cartridge 30 through the supply tube 102. The internal space of the sub-tank 120 communicates with the outside at the upper portion thereof and is open to the atmosphere. The ink in the sub-tank 120 is supplied to the recording head 21 through the ink tube 20.

As shown in FIG. 2, a rod 121 is positioned above each of the first key slots 115A, 115B, 115C, and 115D. The rod 121 protrudes rearward from the end surface 103. The rod 121 is connectable to an upper valve structure 504 of the ink cartridge 30, which will be described later.

A fitting piece 122 and a fitting piece 123 are positioned above each of the first key slots 115A, 115B, 115C, and 115D and below the rod 121. The fitting piece 122 is a plate-like member. The fitting piece 122 protrudes leftward from the inner surface of the right wall 129 in the slot 108A. The fitting piece 122 protrudes leftward from the partition wall 109 defining the right end of the slot 108B. The fitting piece 122 protrudes leftward from the partition wall 109 defining the right end of the slot 108C. The fitting piece 122 protrudes leftward from the partition wall 109 defining the right end of the slot 108D. The fitting piece 123 is a plate-like member. The fitting piece 123 protrudes rightward from the partition wall 109 defining the left end of the slot 108A. The fitting piece 123 protrudes rightward from the partition wall 109 defining the left end of the slot 108B. The fitting piece 123 protrudes rightward from the partition wall 109 defining the left end of the slot 108C. The fitting piece 123 protrudes rightward from the inner surface of the left wall 128 in the slot 108D. The fitting piece 122 and the fitting piece 123 face each other in the left-right direction in the slot 108.

As shown in FIG. 13, in each of the slots 108A, 108B, 108C, and 108D, contacts 125 are positioned on the upper inner surface of the case body 101. The contacts 125 are electrically connectable to the IC board 60 of the ink cartridge 30. Through the contacts 125, a controller of the printer 10 reads information stored in the IC board 60 of the ink cartridge 30 and records information in the IC board 60.

As shown in FIGS. 13A and 13B, an ink receiving member 130 is positioned in the space 162 of the case body 101. The ink receiving member 130 is provided for each of the slots 108A, 108B, 108C, and 108D. The ink receiving member 130 has a front end portion 131 extending in the left-right direction. The front end portion 131 is supported by the case body 101. The ink receiving member 130 has a substantially flat plate shape extending rearward and upward from the front end portion 131, and a rear end portion 132 of the ink receiving member 130 is positioned in the vicinity of the rear end of the supply tube 102. The ink receiving member 130 rotates about the front end portion 131 so that the rear end portion 132 moves substantially in the up-down direction. A coil spring 133 extending along the front-rear direction is positioned between the ink receiving member 130 and the case body 101. The coil spring 133 urges, i.e., pulls the rear end portion 132 of the ink receiving member 130 frontward.

As shown in FIGS. 13A and 13B, the ink receiving member 130 urged, i.e., pulled by the coil spring 133 is held in a state where the rear end portion 132 is the closest to the lower surface of the supply tube 102. In this state, the rear end portion 132 is not in contact with the lower surface of the supply tube 102. The state where the rear end portion 132 of the ink receiving member 130 is the closest to the lower surface of the supply tube 102 is referred to as a closest state of the ink receiving member 130. In the state where the rear end portion 132 of the ink receiving member 130 is the closest to the lower surface of the supply tube 102, the ink receiving member 130 is positioned at a first position. In a state where the ink cartridge 30 is not attached to the supply tube 102, the ink receiving member 130 is in the closest state but not in contact with the lower surface of the supply tube 102. After the ink cartridge 30 is removed from the case body 101, ink may remain on the rear end of the supply tube 102. Such ink moves to a lower portion of the rear end of the supply tube 102 due to gravity and thereafter drips to the rear end portion 132 of the ink receiving member 130 which is in the closest state to the lower surface of the supply tube 102. The received ink moves along the ink receiving member 130 from the rear end portion 132 toward the front end portion 131 away from the ink cartridge 30. Since the ink that remains on the rear end of the supply tube 102 is received by the rear end portion 132 of the ink receiving member 130, it is possible to reduce the possibility that the ink adheres to the lower wall of the case body 101.

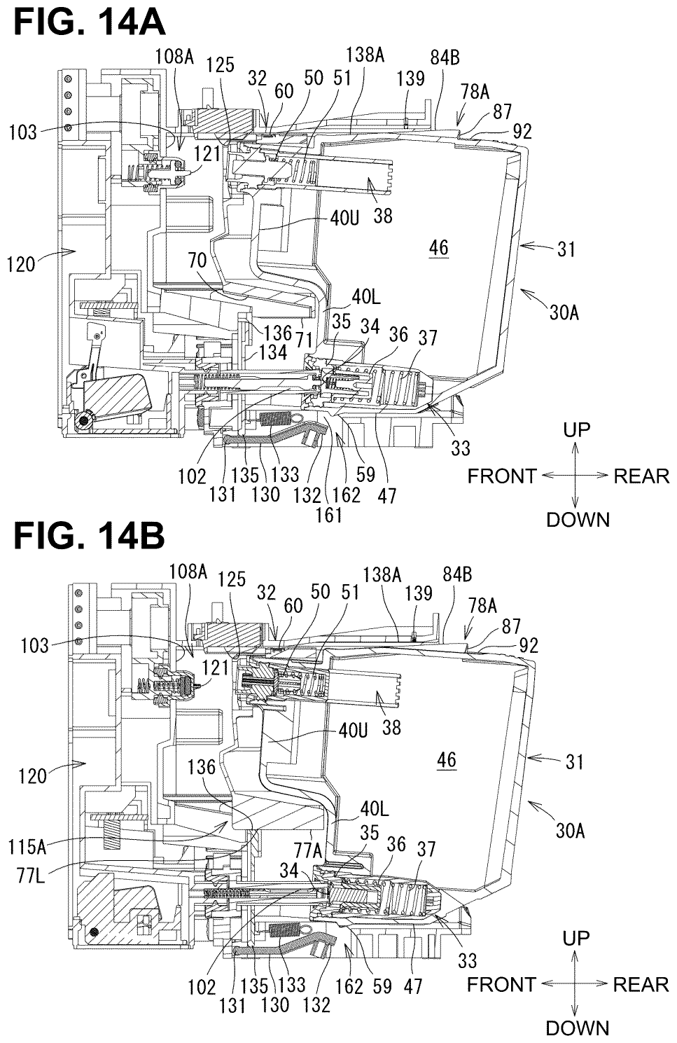

As shown in FIGS. 14A and 14B, in a state where the ink receiving member 130 has moved downward against the pulling force of the coil spring 133, the ink receiving member 130 is in a second position. A space is provided between the ink receiving member 130 at the second position and the supply tube 102 to such an extent that a lower portion of a supply portion 33 of the ink cartridge 30 can be positioned in the space and the supply tube 102 can be received by the supply portion 33. That is, when the supply tube 102 is received in the supply port 34 of the ink cartridge 30 inserted into each of the slots 108A, 108B, 108C, and 108D in the frontward direction, the ink receiving member 130 does not restrict the frontward movement of the ink cartridge 30.

As shown in FIG. 2, the pressing plate 134 is positioned below the cover wall 171 of each of the slots 108A, 108B, 108C, and 108D and in front of the rear wall 173. The pressing plate 134 is supported by the case body 101 so as to be movable in the up-down direction. A lower end 135 of the pressing plate 134 is in contact with the ink receiving member 130 at a portion between the front end portion 131 and the rear end portion 132 of the ink receiving member 130. An upper end 136 of the pressing plate 134 is positioned below the first key slot 115 when the ink cartridge 30 is attached to the cartridge case 110 in the attached state. The pressing plate 134 is positioned below the through hole 140A of the cover wall 171. The pressing plate 134 is positioned in front of the through hole 140B of the rear wall 173. With this configuration, the pressing plate 134 can come into contact with a first key portion 77 of the ink cartridge 30, which will be described later, through the first key slot 115, the through hole 140A, and the through hole 140B. The pressing plate 134 is held at a lifted position by the ink receiving member 130 urged, i.e., pulled by the coil spring 133.

Although details will be described later, when the first key portion 77 of the ink cartridge 30 enters the first key slot 115, the pressing plate 134 is pressed down by the first key portion 77 against the urging, i.e., pulling force of the coil spring 133. When the pressing plate 134 moves downward, the ink receiving member 130 is movable between the first position and the second position.

As shown in FIG. 2, second key slots 138 are arranged at positions corresponding to the respective slots 108A, 108B, 108C, and 108D in a surface 137 positioned on the upper side of the peripheral edge of the case body 101, which defines the opening 112. Specifically, in the case body 101, the slot 108A has a second key slot 138A, the slot 108B has a second key slot 138B, the slot 108C has a second key slot 138C, and the slot 108D has a second key slot 138D. The second key slot 138 is a recess formed in a rear end of a top surface of the case body 101 defining an upper end of the internal space of the case body 101. The second key slot 138 is recessed upward from the top surface. The lower end of the second key slot 138 is continuous with the internal space of the case body 101. A rear end of the second key slot 138 is open toward the outside of the case body 101. A distance between a lower end and an upper end of the opening at the rear end of the second key slot 138 is greater than a distance between a lower end and an upper end of the opening at the front end of the second key slot 138. In the present embodiment, a distance between the lower end and the upper end of the opening of the second key slot 138 gradually decreases from the rear end of the opening toward the front end of the opening. Alternatively, the distance between the lower end and the upper end of the opening of the second key slot 138 may gradually increase and then gradually decrease from the rear end of the opening toward the front end of the opening. The second key slots 138A, 138B, and 138C are respectively positioned to the left of the center of the slots 108A, 108B, and 108C in the left-right direction. The second key slot 138D is positioned to the right of the center of the slot 108D in the left-right direction. A second key portion 78 of the ink cartridge 30 may enter in at least one of the second key slots 138A, 138B, 138C, and 138D.

A locking portion 139 is positioned in a space that defines the opening of each of the second key slots 138A, 138B, 138C, and 138D. The locking portion 139 is a rod-shaped member extending in the left-right direction. The locking portion 139 comes into contact with a locking surface 87 of the ink cartridge 30 when the ink cartridge 30 is attached to the cartridge case 110 in the attached state.

### [Ink Cartridge 30]

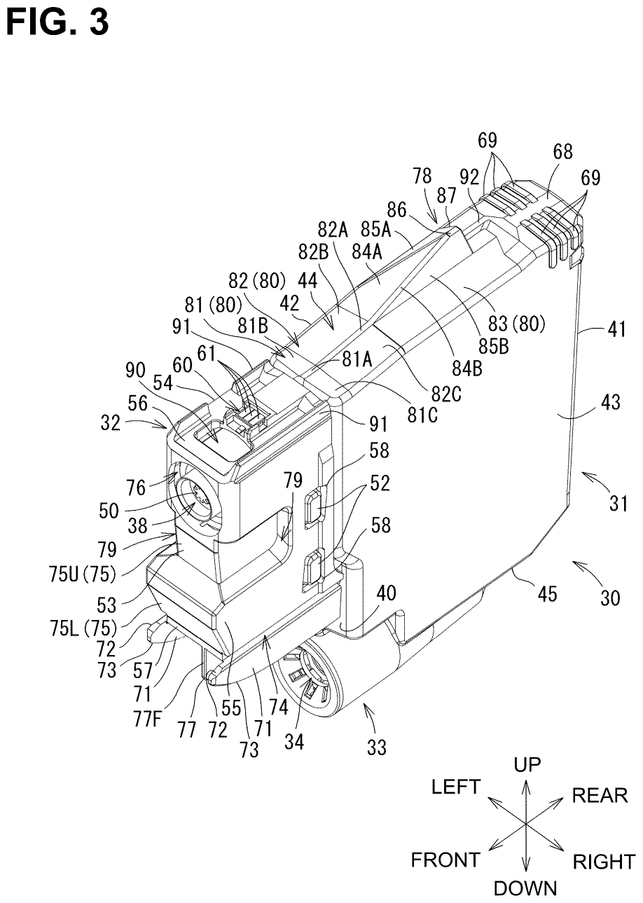

The ink cartridge 30 is a container in which ink as a liquid is stored. As shown in FIGS. 3 to 10, the ink cartridge 30 includes a container body 31, a lower support member 11, a lower valve mechanism 12, a cover 32, and an IC board 60. The container body 31 is an example of a housing. The lower support member 11 is an example of a first support member. The lower valve mechanism 12 is an example of a first valve mechanism. The cover 32 covers a front portion of the container body 31. The ink cartridge 30 is inserted frontward into a corresponding one of the slots 108A, 108B, 108C, and 108D with the cover 32 facing the end surface 103 of the case body 101.

The container body 31 has a substantially thin flat cubic shape in which the length in the left-right direction is smaller than the length in the up-down direction and the length in the front-rear direction. The container body 31 includes a supply portion 33, a first key portion 77, and a second key portion 78. The supply portion 33 is an example of a cylindrical portion.

The container body 31 includes a front wall 40, a rear wall 41 opposed to the front wall 40 in the front-rear direction, a left wall 42 connecting the front wall 40 and the rear wall 41, a right wall 43 opposed to the left wall 42 in the left-right direction, an upper wall 44 connecting the front wall 40 and the rear wall 41, and a lower wall 45 opposed to the upper wall 44 in the up-down direction. The container body 31 has an upper surface 80 which is an outer surface of the upper wall 44. The outer surface of the front wall 40 faces frontward. The rear wall 41 has a rear surface 62 facing rearward. The outer surface of the left wall 42 faces leftward. The outer surface of the right wall 43 faces rightward. The outer surface of the upper wall 44, i.e., the upper surface 80 faces upward. The outer surface of the lower wall 45 faces downward.

As shown in FIG. 13, the front wall 40, the rear wall 41, the left wall 42, the right wall 43, the upper wall 44, and the lower wall 45 define a chamber 46 in the internal space of the container body 31. The front wall 40, the rear wall 41, the left wall 42, the right wall 43, the upper wall 44, and the lower wall 45 have translucency to the extent that the liquid level of the ink stored in the chamber 46 can be visually recognized from the outside. The container body 31 is, for example, an integrally molded product made of a synthetic resin.

The front wall 40 has an upper front wall 40U positioned on the upper side and a lower front wall 40L positioned on the lower side. The upper front wall 40U is positioned frontward of the lower front wall 40L in the front-rear direction. A space behind the upper front wall 40U in the front-rear direction is also a part of the chamber 46. In other words, the upper portion of the chamber 46 extends further frontward than the lower portion of the chamber 46. The lower front wall 40L is continuous with the supply portion 33.

As shown in FIG. 10, the left wall 42 includes a front left wall 42F positioned on the front side in the front-rear direction and a rear left wall 42R positioned on the rear side in the front-rear direction. As shown in FIG. 5, the right wall 43 includes a front right wall 43F positioned on the front side in the front-rear direction and a rear right wall 43R positioned on the rear side in the front-rear direction. The front left wall 42F and the front right wall 43F are continuous with the upper front wall 40U. The rear left wall 42R and the rear right wall 43R are continuous with the rear wall 41. A space between the front left wall 42F and the front right wall 43F is a part of the chamber 46. A distance in the left-right direction between an outer surface of the front left wall 42F and an outer surface of the front right wall 43F is smaller than a distance in the left-right direction between an outer surface of the rear left wall 42R and an outer surface of the rear right wall 43R.

Two protrusions 52 are positioned on the front left wall 42F. Two protrusions 52 are positioned on the front right wall 43F. On the front left wall 42F, the two protrusions 52 are separated from each other in the up-down direction. On the front right wall 43F, the two protrusions 52 are separated from each other in the up-down direction. The protrusion 52 has a substantially quadrangular shape in a side view. The protrusion 52 passes through a through hole 76 of the cover 32 described later.

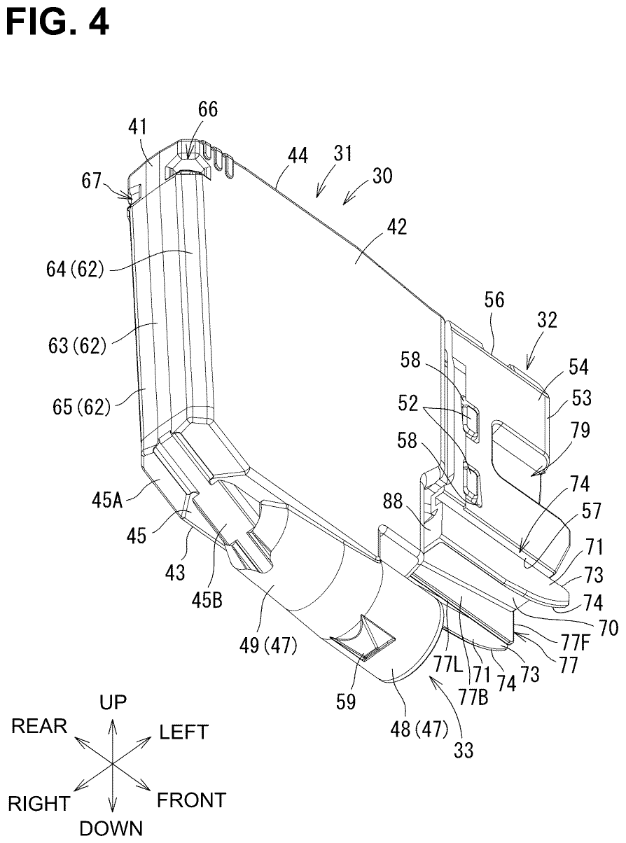

As shown in FIGS. 3 and 4, the supply portion 33 is a cylindrical member that extends in the front rear direction. The supply portion 33 has an outer peripheral surface extending in the front-rear direction. The outer peripheral surface is a curved surface curved in a circumferential direction with the front-rear direction as an axis. The supply portion 33 is positioned at a lower end of the container body 31, and a part of an outer surface of the supply portion 33 constitutes a lower surface 47 of the container body 31. The supply portion 33 has a supply port 34 through which the ink flows out of the ink cartridge 30. The supply port is positioned at the front end of the supply portion 33. The supply port 34 is circular when viewed from the front.

The lower surface 47 includes a lower half of a peripheral surface having an axis in the front-rear direction. The lower surface 47 includes a first surface 48 having a cylindrical shape in the front-rear direction and a second surface 49 positioned rearward of the first surface 48 in the front-rear direction. The outer diameter of the supply portion 33 decreases from the first surface 48 toward the second surface 49.

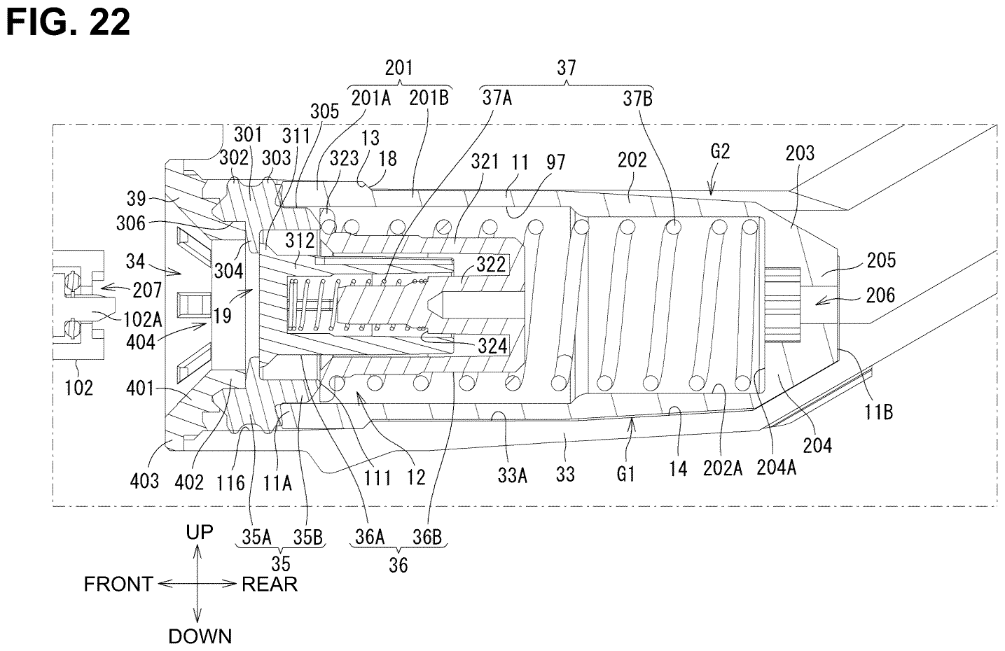

As shown in FIG. 13, the supply portion 33 has a substantially cylindrical shape and has an internal space. The internal space of the supply portion 33 communicates with the supply port 34 at the front in the front-rear direction and communicates with the chamber 46 at the rear in the front-rear direction. Ink in the internal space of the supply portion 33 can flow out to the outside of the ink cartridge 30 through the supply port 34. As shown in FIG. 22, an inner peripheral surface 33A of the supply portion 33 has a step surface 13 having an annular shape. The step surface 13 is inclined inwardly such that the inner diameter slightly decreases toward the rear. The inner peripheral surface 33A has a press-fit surface 14. The press-fit surface 14 is located on the lower side of the inner peripheral surface 33A. The press-fit surface 14 is located rearward of the middle of the supply portion 33 in the front-rear direction. The press-fit surface 14 is inclined inwardly such that the inner diameter slightly decreases toward the rear.

As shown in FIG. 13, the supply portion 33 has a substantially cylindrical shape and has an internal space. The internal space of the supply portion 33 communicates with the supply port 34 at the front in the front-rear direction and communicates with the chamber 46 at the rear in the front-rear direction. Ink in the internal space of the supply portion 33 can flow out to the outside of the ink cartridge 30 through the supply port 34. As shown in FIG. 22, an inner peripheral surface 33A of the supply portion 33 has a step surface 13 having an annular shape. The step surface is positioned rearward of the supply port 34. The step surface 13 is inclined inwardly such that the inner diameter slightly decreases toward the rear. In other words, the step surface 13 defines an internal space of the supply portion 33 such that the internal space of the supply portion 33 gradually narrows toward the rear. The step surface 13 is an example of a tapered surface. The inner peripheral surface 33A has a press-fit surface 14. The press-fit surface 14 is located on the lower side of the inner peripheral surface 33A. The press-fit surface 14 is located rearward of the middle of the supply portion 33 in the front-rear direction. The press-fit surface 14 is inclined inwardly such that the inner diameter slightly decreases toward the rear.

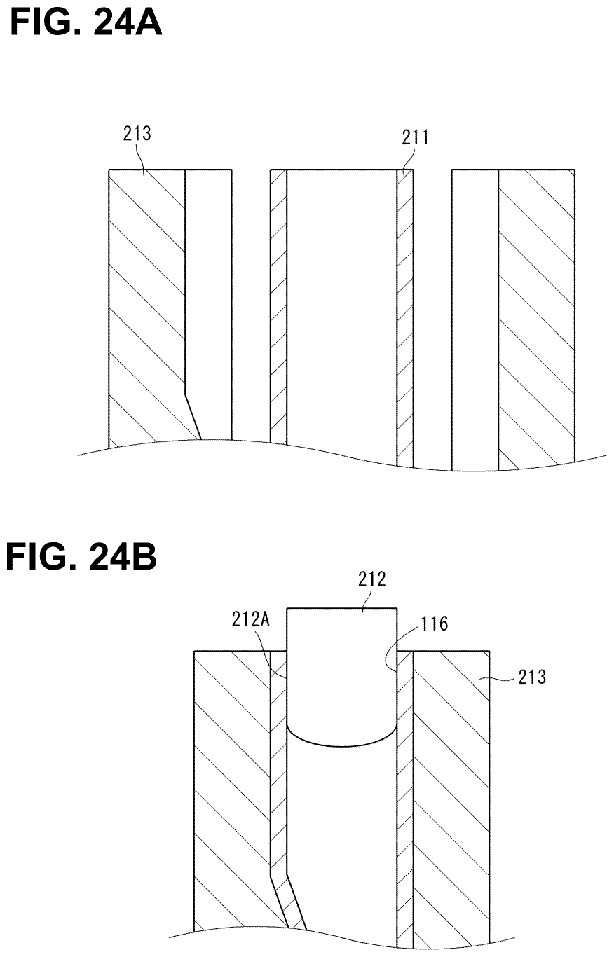

The container body 31 is integrally formed by blow molding, that is, the container body 31 is integrally blow molded. Specifically, first, as shown in FIG. 24A, a molten cylindrical parison 211 is molded from a blow molding machine. Next, as shown in FIG. 24B, the parison 211 is sandwiched between the molds 213 in a state where the blow pin 212 is inserted into the parison 211, and air is injected into the parison 211 from the blow pin 212. At this time, an upper end portion of the parison 211 is sandwiched between the outer peripheral surface 212A of the blow pin 212 and the inner surface of the mold 213. As a result, the supply portion 33 having a transfer surface 116 to which the shape of the outer peripheral surface 212A of the blow pin 212 is transferred as a part of the inner peripheral surface 33A is formed. The transfer surface 116 is positioned between the supply port 34 and the step surface 13 on the inner peripheral surface 33A of the feed portion 33. In FIGS. 24A and 24B, only a portion of the mold 213 for molding the supply portion 33 is shown, and a portion of the mold 213 for molding the chamber 46 is omitted. The blow pin 212 is an example of an air nozzle.

The lower support member 11 is accommodated in the internal space of the supply portion 33. The lower support member 11 has a substantially cylindrical shape extending in the front-rear direction. The lower support member 11 is an injection molded product. Specifically, the lower support member 11 includes a cylindrical portion 201, a reduced diameter portion 202, a conical portion 203, and a base 204.

The cylindrical portion 201 has a large-diameter portion 201A having a large outer diameter and a small-diameter portion 201B having an outer diameter slightly smaller than the outer diameter of the large-diameter portion 201A. The large-diameter portion 201A is located at the front end portion of the lower support member 11. A front end portion 11A of the large-diameter portion 201A is located rearward of the supply port 34. A gap 18 is formed between the rear end of the large-diameter portion 201A and the small-diameter portion 201B. The small-diameter portion 201B extends rearward from the rear end of the large-diameter portion 201A. The inside diameter of the small-diameter portion 201B is equal to the inside diameter of the large-diameter portion 201A. That is, the inner peripheral surface of the cylindrical portion 201 is a single surface from the front end to the rear end.

The reduced diameter portion 202 extends rearward from the rear end of the small-diameter portion 201B. The outer peripheral surface of the reduced diameter portion 202 is slightly inclined inward such that the outer diameter slightly decreases toward the rear. The inside diameter of the reduced diameter portion 202 is smaller than the inside diameter of the large-diameter portion 201A or the inside diameter of the small-diameter portion 201B. The inner diameter of the reduced diameter portion 202 is even from the front end to the rear end.

The conical portion 203 extends rearward from the rear end of the reduced diameter portion 202. The outer peripheral surface of the conical portion 203 is inclined inward such that the outer diameter decreases toward the rear. The rear end of the conical portion 203 has a circular through hole 206 penetrating in the front-rear direction. The through hole 206 is defined by a partition wall 205 that annularly protrudes inward from the inner peripheral surface of the conical portion 203. The upper end of the through hole 206 is slightly lower than the upper end of the opening 207 of the supply tube 102 in the up-down direction. The upper end of the through hole 206 may be aligned with the upper end of the opening 207 of the supply tube 102 in the up-down direction or may be slightly lower than the upper end of the opening 207 of the supply tube 102 in the up-down direction.

The base 204 annularly protrudes inward from the inner peripheral surface of the conical portion 203. The base 204 has a spring support surface 204A that faces forward.

The gap 18 of the lower support member 11 is in contact with the step surface 13 of the supply portion 33 in an annular manner. In this configuration, the lower support member 11 is positioned in the front-rear direction. The lower surface of the outer peripheral surface of the reduced diameter portion 202 is in pressure contact with the press-fit surface 14 of the supply portion 33. Thus, a gap G1 between the lower surface of the outer peripheral surface of the reduced diameter portion 202 and the press-fit surface 14 is smaller than a gap G2 between the upper surface of the outer peripheral surface of the reduced diameter portion 202 and the inner peripheral surface 33A of the supply portion 33. The press-fit surface 14 is an example of at least a part of an inner surface of a tubular portion with which a support member is in pressure contact.

At least a portion of the lower valve mechanism 12 is accommodated in the internal space of the lower support member 11. Specifically, the lower valve mechanism 12 includes a seal member 35, a valve 36, a coil spring 37, and a cap 39.

The seal member 35 is an annular member made of an elastic member, for example, rubber or the like. The seal member 35 is positioned in the supply port 34 and in the internal space of the supply portion 33. The seal member 35 is positioned slightly rearward of the supply port 34 and is in close contact with the transfer surface 116 of the supply portion 33. Specifically, the seal member 35 has a first seal portion 35A and a second seal portion 35B.

The seal member 35 is an annular member made of an elastic member, for example, rubber, and has a circular through hole 19 along the front-rear direction. The seal member 35 is located in the internal space of the supply portion 33. The seal member 35 is in close contact with the transfer surface 116 of the supply portion 33 at a position slightly rearward of the supply port 34. Specifically, the seal member 35 has a front portion 35A and a rear portion 35B. The front portion 35A is an example of a first portion. The rear portion 35B is an example of a second portion.

The front portion 35A includes a tube body 301 extending along the front-rear direction, a first protrusion 302 and a second protrusion 303 located on the outer peripheral surface of the tube body 301, and a third protrusion 304 located on the inner peripheral surface of the tube body 301. The rear end of the tube body 301 is in contact with a front end portion 11A of the lower support member 11. The front end portion 11A of the lower support member 11 is an example of a contact portion. The first protrusion 302 is located at a front end portion of the outer peripheral surface of the tube body 301. The first protrusion 302 has a ring shape extending over the entire circumference of the outer peripheral surface of the tube body 301. The first protrusion 302 is in close contact with the transfer surface 116 of the supply portion 33 over the entire circumference. The first protrusion 302 is an example of a first seal portion. The second protrusion 303 is located at a rear end portion of the outer peripheral surface of the tube body 301. The second protrusion 303 has a ring shape extending over the entire circumference of the outer peripheral surface of the tube body 301. The second protrusion 303 is in close contact with the transfer surface 116 of the inner peripheral surface of the supply portion 33 over the entire circumference. The second protrusion 303 is an example of a first seal portion. The third protrusion 304 is positioned between the first protrusion 302 and the second protrusion 303 in the front-rear direction. The third protrusion 304 has an annular shape extending over the entire circumference of the inner peripheral surface of the tube body 301. The radially inner end of the third protrusion 304 defines the through hole 19. The through hole 19 is an example of a first through hole.

The rear portion 35B has a cylindrical shape extending rearward from the inner peripheral side of the rear end of the tube body 301. The rear portion 35B is spaced radially inward from the inner peripheral surface 33A of the supply portion 33. The outer peripheral surface 305 of the rear portion 35B is in contact with the inner peripheral surface of the front end portion of the lower support member 11. The rear end 111 of the rear portion 35B is in contact with the valve 36.

The valve 36 is positioned in the internal space of the lower support member 11. The valve 36 is movable in the front-rear direction in the internal space of the lower support member 11. The supply port 34 is sealed by the valve 36 being in contact with the seal member 35. In particular, the valve 36 has a first valve 36A and a second valve 36B.

The first valve 36A includes a contact portion 311 that is in contact with the rear end of the third protrusion 304 of the front portion 35A, and a support portion 312 having a cylindrical shape and extending rearward from the rear end of the contact portion 311. The contact portion 311 has a circular flat plate shape expanding in the up-down direction and the left-right direction. The contact portion 311 opens and closes the through hole 19. The first valve 36A is movable between a closed position where the front end surface of the contact portion 311 is in contact with the rear end of the third protrusion 304 and an open position located rearward of the closed position. The third protrusion 304 is an example of a second seal portion.

The second valve 36B includes a accommodating portion 321 having a cylindrical shape and extending in the front-rear direction, a cylindrical portion 322 located in an internal space of the accommodating portion 321, and a flange portion 323 located at a front end of the accommodating portion 321. The accommodating portion 321 has a cylindrical shape with a closed rear end. The inside diameter of the accommodating portion 321 is larger than the outside diameter of the support portion 312 of the first valve 36A. The cylindrical portion 322 has a columnar shape extending forward from the rear end of the accommodating portion 321. The support portion 312 of the first valve 36A is positioned between the outer peripheral surface of the cylindrical portion 322 and the inner peripheral surface of the accommodating portion 321. The cylindrical portion 322 has a spring support surface 324 facing forward. The spring support surface 324 is positioned at the middle in the front-rear direction on the outer peripheral surface of the cylindrical portion 322. The flange portion 323 is positioned at a front end of the outer peripheral surface of the accommodating portion 321. The flange portion 323 protrudes in an annular shape from the outer peripheral surface of the accommodating portion 321. The protruding end of the flange portion 323 is close to the inner peripheral surface 97 of the cylindrical portion 201 of the lower support member 11. Thus, the position of the second valve 36B is determined in a direction orthogonal to the front-rear direction. As a result, the second valve 36B is guided in the front-rear direction in a state where the posture of the second valve SL is maintained. The inner peripheral surface 97 of the cylindrical portion 201 is an example of a second guide surface. The second valve 36B is movable between a closed position where the front surface of the flange portion 323 is in contact with the rear end 111 of the rear portion 35B and an open position located rearward of the closed position. The rear end 111 of the rear portion 35B is an example of a second seal portion.

The coil spring 37 biases the valve 36 toward the seal member 35. To be specific, the coil spring 37 includes a first coil spring 36A that biases the first valve 37A and a second coil spring 36B that biases the second valve 37B.

The coil spring 37 biases the valve 36 toward the seal member 35 so that the valve 36 contacts the seal member 35. Specifically, the coil spring 37 includes a first coil spring 36A that biases the first valve 37A and a second coil spring 36B that biases the second valve 37B. The first coil spring 37A is compressible in the front-rear direction. The rear end of the first coil spring 37A is supported by the spring support surface 324 of the cylindrical portion 322. The front end of the first coil spring 37A is in contact with the rear end of the contact portion 311 of the first valve 36A. In this configuration, the first coil spring 37A presses the front surface of the contact portion 311 against the rear end of the third protrusion 304 of the front portion 35A.

The second coil spring 37B is compressible in the front-rear direction. The spring constant of the second coil spring 37B is greater than the spring constant of the first coil spring 37A. The outer surface of the second coil spring 37B is close to the inner peripheral surface 202A of the reduced diameter portion 202 of the lower support member 11. In this configuration, the second coil spring 37B is guided in the front-rear direction. The inner peripheral surface 202A of the reduced diameter portion 202 is an example of a first guide surface. The rear end of the second coil spring 37B is supported by the spring support surface 204A of the base 204. The front end of the second coil spring 37B is in contact with the rear end of the flange portion 323. In this configuration, the second coil spring 37B presses the front surface of the flange portion 323 against the rear end of the rear portion 35B. The coil spring 37 is an example of a bias member.

The cap 39 is attached to the transfer surface 116 of the supply portion 33 around the supply port 34. The cap 39 is bonded to the transfer surface 116 of the supply portion 33 by an adhesive. The cap 39 may be fixed to the transfer surface 116 of the supply portion 33 by welding.

The cap 39 has a substantially conical cylindrical shape. Specifically, the cap 39 includes a conical tube body 401, a cylindrical tube body 402, and a flange body 403. The conical tube body 401 has a conical tube shape extending in the front-rear direction. The inner peripheral surface of the conical tube body 401 is inclined outward such that the inner diameter increases toward the front. The rear end of the conical tube body 401 is in contact with the front end of the front portion 35A. The cylindrical tube body 402 has a cylindrical shape extending rearward from the inner peripheral side of the rear end of the conical tube body 401. The outer peripheral surface of the cylindrical tube body 402 is in contact with the inner peripheral surface 306 of the front portion 35A. The rear end of the cylindrical tube body 402 is contact with the front surface of the third protrusion 304. The inner peripheral surface of the cylindrical tube body 402 is continuous with the inner peripheral surface of the conical tube body 401. The inner peripheral surface of the cylindrical tube body 402 and the inner peripheral surface of the conical tube body 401 define a through hole 404 penetrating in the front-rear direction. The through hole 404 is an example of a second through hole. The flange body 403 is positioned at the front end of the outer peripheral surface of the conical tube body 401. The flange body 403 protrudes radially outward from the outer peripheral surface of the conical cylindrical body 401. The rear surface of the flange body 403 is in contact with the front end of the supply portion 33. The cap 39 is an example of a contact member.

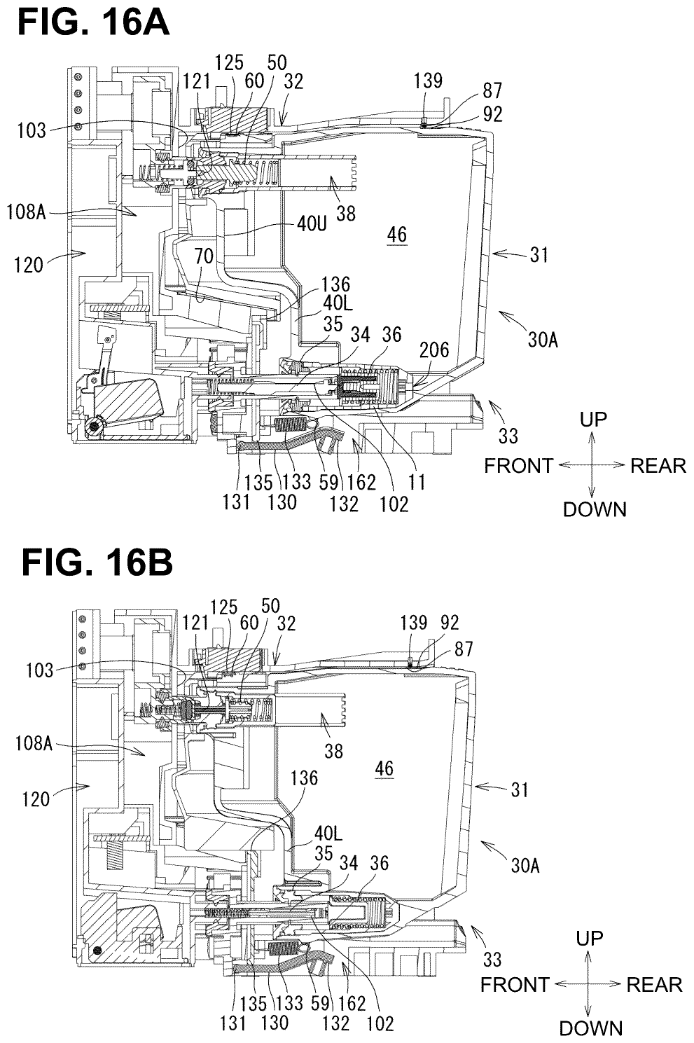

When the supply tube 102 is received in the supply port 34, the supply tube 102 presses the first valve 37A rearward against the urging force of the first coil spring 36A, whereby the first valve 36A moves rearward from the closed position toward the open position. As the first valve 36A moves rearward, the biasing force of the first coil spring 37A increases. When the urging force of the first coil spring 37A becomes stronger than the urging force of the second coil spring 37B, the second valve 36B moves rearward from the closed position toward the open position against the urging force of the second coil spring 37B. Thus, the internal space of the lower support member 11 and the internal space of the supply tube 102 communicate with each other. As a result, as shown in FIG. 16, the ink in the chamber 46 flows into the internal space of the supply tube 102 through the through hole 206 and the internal space of the lower support member 11. The third protrusion 304 of the seal member 35 is in liquid-tight contact with the outer surface of the supply tube 102.

As shown in FIG. 4, a convex portion 59 protruding downward is positioned on the first surface 48 of the supply portion 33. As shown in FIG. 7, an outline of a portion where the convex portion 59 is continuous with the first surface 48 has a substantially square shape when viewed upward from below in the up-down direction, and a length of the outline in the front-rear direction is substantially equal to a length of the outline in the left-right direction. Both side surfaces of the convex portion 59 in the left-right direction are downward triangles. Each side surface of the convex portion 59 in the left-right direction is a tapered surface that is inclined toward the center of the convex portion 59 in the left-right direction as the side surface extends downward. In other words, the convex portion 59 has a tapered shape in which the length in the left-right direction gradually decreases as the side surface extends downward.

As shown in FIG. 13, the upper front wall 40U of the container body 31 has an atmosphere communication portion 502 that has a cylindrical shape and defines an atmosphere communication port 501 that connects the vicinity of the upper end of the chamber 46 and the outside. The atmosphere communication portion 502 extends rearward from the atmosphere communication port 501. The atmosphere communication port 501 is positioned frontward of the supply port 34 in the front-rear direction. The atmosphere communication port 501 is open frontward in the upper front surface 40U.

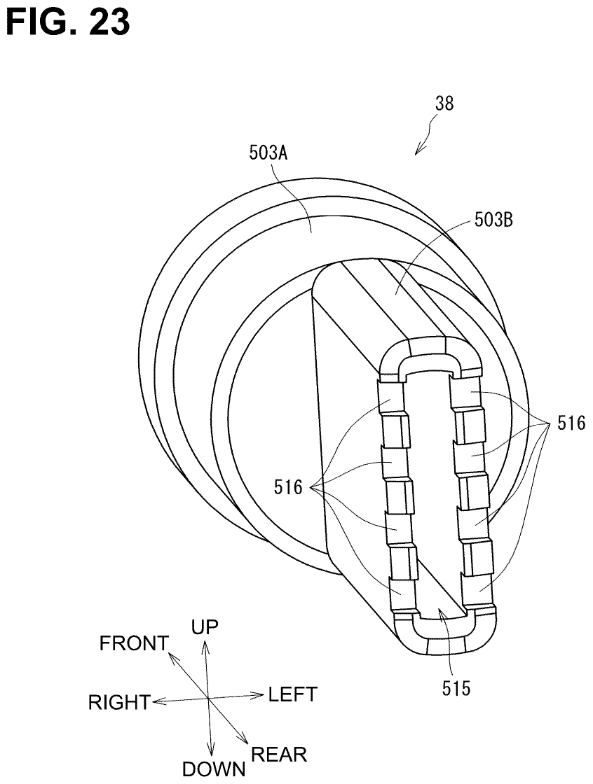

The upper support member 38 that has a substantially cylindrical shape is inserted into the internal space of the atmosphere communication portion 502 through the atmosphere communication port 501. The upper support member 38 is in pressure contact with the inner peripheral surface of the atmosphere communication portion 502. As shown in FIGS. 13 and 23, the upper support member 38 includes a cylindrical main body portion 503A having a cylindrical shape and a quadrangular tube 503B having a quadrangular tube shape. The inner peripheral surface of the cylindrical main body portion 503A defines a circular air flow path. The quadrangular tube 503B extends rearward from the rear end of the cylindrical main body portion 503A. The inner space of the quadrangular tube 503B communicates with the inner space of the cylindrical main body portion 503A. The inner peripheral surface of the quadrangular tube 503B defines a quadrangular air flow path that is longer in the up-down direction than in the left-right direction. A cross-sectional area of the air flow path of the quadrangular tube 503B cut by a plane orthogonal to the front-rear direction is smaller than a cross-sectional area of the air flow path of the cylindrical body portion 503A cut by a plane orthogonal to the front-rear direction. The rear end of the quadrangular tube 503B defines an opening 515 that opens rearward. The opening 515 has a quadrangular shape that is longer in the up-down direction than in the left-right direction. The quadrangular tube 503B has a plurality of recesses 516 recessed forward from the rear end of the quadrangular tube 503B. The plurality of recesses 516 are positioned at equal intervals in the up-down direction. Accordingly, the formation of a meniscus of ink in the opening 515 is reduced.

As shown in FIG. 13, the length L1 of the upper support member 38 in the front-rear direction is greater than the length L2 of the lower support member 11 in the front-rear direction. The rear end of the upper support member 38 is positioned forward of the rear end of the lower support member 11 in the front-rear direction. In other words, the rear end of the lower support member 11 is positioned rearward of the rear end of the upper support member 38.

The upper valve mechanism 504 is positioned in the internal space of the upper support member 38. The upper valve mechanism 504 includes a valve seat 17, a valve 50, and a coil spring 51.

The valve seat 17 is positioned at the atmosphere communication port 501. The valve seat 17 is fitted into the inner peripheral surface of the atmosphere communication portion 502. The valve seat 17 has an annular shape and defines a through hole 17A extending in the front-rear direction. The rear end of the valve seat 17 is in contact with the front end of the upper support member 38.

The valve 50 includes a columnar portion 50A having a cylindrical shape and an extending portion 50B. The columnar portion 50A is inserted into the through hole 17A of the valve seat 17 so as to be movable in the front-rear direction. The extending portion 50B extends outward in the radial direction from the outer peripheral surface of the columnar portion 50A. The outer diameter of the columnar portion 50A is smaller than the inner diameter of the through hole 17A. Thus, a gap through which air can flow is provided between the outer peripheral surface of the columnar portion 50A and the inner peripheral surface of the through hole 17A. The front end of the columnar portion 50A is located forward of the through hole 17A. The rear end of the columnar portion 50A is located rearward of the through hole 17A. The extending portion 50B has an annular shape extending over the entire circumference of the outer peripheral surface of the columnar portion 50A in the circumferential direction. The front surface of the extending portion 50B is in contact with the rear end of the valve seat 17.

The coil spring 51 is positioned in the internal space of the upper support member 38. The front end of the coil spring 51 is positioned above and forward of the supply port 34 of the supply portion 33. The front end of the coil spring 51 is positioned forward of the second key portion 78. The coil spring 51 biases the valve 50 forward. The front end of the coil spring 51 is in contact with the rear surface of the extending portion 50B of the valve 50. The rear end of the coil spring 51 is supported by the inner peripheral surface of the upper support member 38. Thus, the front surface of the extending portion 50B is pressed against the rear end of the valve seat 17. As a result, the atmosphere communication port 501 is sealed. As will be described in detail later, when the valve 50 moves rearward against the urging force of the coil spring 51, the atmosphere communication port 501 is opened, and air can flow between the outside and the chamber 46. The upper valve mechanism 504 is an example of a second valve mechanism.

The cover 32 has a substantially quadrangular parallelepiped shape whose length in the up-down direction and length in the front-rear direction are smaller than a length in the up-down direction and a length in the front-rear direction of the container body 31. The cover 32 has a box shape having an opening facing rearward. The cover 32 is attached to the container body 31 so as to substantially cover the upper front wall 40U, the front left wall 42F, and the front right wall 43F.

The cover 32 includes a front wall 53, a left wall 54 extending rearward from a left end of the front wall 53, a right wall 55 opposed to the left wall 54 in the left-right direction, an upper wall 56 extending rearward from an upper end of the front wall 53, and a lower wall 57 opposed to the upper wall 56 in the up-down direction. The front wall 53, the left wall 54, the right wall 55, the upper wall 56, and the lower wall 57 define an internal space of the cover 32. The opening of the cover 32 is defined by rear ends of the front wall 53, the left wall 54, the right wall 55, the upper wall 56, and the lower wall 57.

The front wall 53 is a part of the front wall of the ink cartridge 30. The left wall 54 is a part of a left wall of the ink cartridge 30. The right wall 55 is a part of the right wall of the ink cartridge 30. The upper wall 56 is a part of an upper wall of the ink cartridge 30. The upper wall 56 is a part of an upper wall of the ink cartridge 30.

The length of the cover 32 in the up-down direction is smaller than the length of the container body 31 in the up-down direction. The length of the cover 32 in the front-rear direction is smaller than the length of the container body 31 in the front-rear direction. The distance of the cover 32 in the left-right direction is slightly greater than the distance between the outer surface of the front left wall 42F and the outer surface of the front right wall 43F of the container body 31 in the left-right direction, and is substantially the same as the distance between the outer surface of the rear left wall 42R and the outer surface of the rear right wall 43R in the left-right direction.

The left wall 54 has two through holes 58 spaced apart in the up-down direction. The right wall 55 has two through holes 58 spaced apart in the up-down direction. The protrusions 52 on the front left wall 42F are positioned in the through holes 58 of the left wall 54, and the protrusions 52 on the front right wall 43F are positioned in the through holes 58 of the right wall 55. The through hole 58 has a substantially quadrangular shape. Specifically, the length of each through hole 58 in the up-down direction is greater than the length thereof in the front-rear direction. The through hole 58 is sufficiently larger than the outer shape of the protrusion 52. That is, the length of each through hole 58 in the up-down direction is greater than the length of each protrusion 52 in the up-down direction. The length of each through hole 58 in the front-rear direction is greater than the length of each protrusion 52 in the front-rear direction. The container body 31 and the cover 32 are assembled by inserting the protrusions 52 into the corresponding through holes 58. Since the through hole 58 is larger than the outer shape of the protrusion 52, the cover 32 is relatively movable in the up-down direction and the front-rear direction with respect to the container body 31 in a state where the container body 31 and the cover 32 are assembled. Since the through hole 58 is sufficiently larger than the outer shape of the protrusion 52, the cover 32 can move relative to the container body 31 not only in the up-down direction and the front-rear direction, but also in a direction in which the cover 32 rotates relative to the container body 31 along a plane extending in the up-down direction and the front-rear direction.

The cover 32 covers the upper front wall 40U of the container body 31 in the state in which the cover 32 is attached to the container body 31. The front wall 53 of the cover 32 is positioned frontward of the supply port 34. The supply port 34 is positioned below the lower wall 57 of the cover 32.

The IC board 60 is positioned on the upper wall 56 of the cover 32. The IC board 60 extends in the front-rear direction and the left-right direction. The IC board 60 is positioned above the supply port 34. The IC board 60 includes a substrate formed of, for example, silicone or glass epoxy, an IC mounted on the substrate and three electrodes 61 mounted on the substrate. Note that the IC does not appear in the drawings. Three electrodes 61 face upward. The IC board 60 may be a flexible substrate having flexibility.

The IC board 60 is bonded to the upper wall 56 of the cover 32 by, for example, a photo-curable resin. The IC board 60 may be bonded to the cover 32 by an adhesive other than the photocurable resin, or may be attached to the cover 32 by a means other than bonding, such as fitting.

The electrodes 61 of the IC board 60 come into contact with the contacts 125 in the process in which the ink cartridge 30 is inserted into the cartridge case 110. In the attached state where the ink cartridge 30 is attached to the cartridge case 110, the IC board 60 is in contact with and electrically connected to the contacts 125.

The IC is a semiconductor integrated circuit. Information related to the ink cartridge 30 is readably stored in the IC. The information related to the ink cartridge 30 is, for example, data indicating information such as a lot number, a manufacturing date, and an ink color.

The electrode 61 is electrically connected to the IC. The electrode 61 extends in the front-rear direction. The electrodes 61 are arranged on the upper surface of the IC board 60 so as to be spaced apart from each other in the left-right direction. The electrode 61 is exposed on the upper surface of the IC board 60 so as to be electrically accessible.

As shown in FIG. 3, the upper wall 56 of the cover 32 has a through hole 90 in front of the IC board 60. The atmosphere communication portion 502 is positioned below the through hole 90. Guide pieces 91 extending in the front-rear direction protrude upward near both ends of the upper wall 56 of the cover 32 in the left-right direction. The IC board 60 is positioned between the one guide piece 91 and the other guide piece 91 in the left-right direction. The guide piece 91 functions as a guide for the cover 32 to move in the front-rear direction when the cover 32 is inserted into the cartridge case 110.

As shown in FIG. 7, a lower surface 70 which is an outer surface of the lower wall 57 of the cover 32 is positioned above and frontward of the supply port 34. The lower surface 70 is a flat surface extending rearward from the lower end of the front wall 53, and is inclined so as to extend downward toward the rear.

The cover 32 has walls 71 extending downward from both ends of the lower surface 70 in the left-right direction. The one wall 71 and the other wall 71 are spaced apart from each other in the left-right direction. The wall 71 is a plate-like member extending in the up-down direction and the front-rear direction and having a thickness in the left-right direction. The length of the wall 71 in the front-rear direction is greater than the length of the wall 71 in the left-right direction and the length of the wall 71 in the up-down direction. The length of the wall 71 in the up-down direction is greater than the length thereof in the left-right direction. As shown in FIG. 5, the front surface of the wall 71 has a first front surface 72 positioned at an upper portion thereof and a second front surface 73 positioned at a lower portion thereof. A front end of the first front surface 72 is inclined so as to extend upward as the front end of the first front surface 72 extends toward the rear. The second front surface 73 is inclined so as to extend downward as the front end of the second front surface 73 extends toward the rear.

As shown in FIG. 7, the rear ends of the two walls 71 contact with a sub-front wall 88 (also referred to as a wall), and the two walls 71 extend frontward from the sub-front wall 88. The sub-front wall 88 extends downward from the rear end of the lower surface 70. The sub-front wall 88 has a plate shape extending in the up-down direction and the left-right direction and having a thickness in the front-rear direction. The length of the sub-front wall 88 in the left-right direction is greater than the length thereof in the up-down direction. The outer surface of the sub-front wall 88 facing frontward is a part of the front surface of the cover 32.

In the left wall 54 of the cover 32, a groove 74 (also referred to as a first groove 74) extending in the front-rear direction is positioned above the wall 71. The first groove 74 is positioned leftward and upward of the first key portion 77 and extends in the front-rear direction. In the right wall 55 of the cover 32, a groove 74 (also referred to as a second groove 74) extending in the front-rear direction is positioned above the wall 71. The second groove 74 is positioned rightward and upward of the first key portion 77 and extends in the front-rear direction. A longitudinal direction of the groove 74 is the front-rear direction. As shown in FIG. 8, the groove 74 is defined by a surface 74L facing upward, a surface 74U facing the surface 74L in the up-down direction, and a surface 74M connecting the surface 74L and the surface 74U. The front end of the groove 74 is open frontward in the front wall 53 of the cover 32. That is, the first groove 74 has an opening at a front end and a left end, and the second groove has an opening at a front end and a right end. As shown in FIGS. 3 to 10, the first front surface 72 of the one wall 71 serves as a guide for guiding the rib 118 of the cartridge case 110 into the one groove 74. The first front surface 72 of the other wall 71 serves as a guide for guiding the rib 119 of the cartridge case 110 into the first groove 74. One of the grooves 74 has a length capable of receiving the rib 118 of the case body 101 in the front-rear direction, and the other groove 74 has a length capable of receiving the rib 119 of the case body 101 in the front-rear direction. Specifically, the distance between the surface 74L and the surface 74U of the groove 74 in the up-down direction is greater than each of the lengths of the rib 118 and the rib 119 of the case body 101 in the up-down direction. The position of the cover 32 with respect to the case body 101 in the up-down direction is determined by the contact of the surface 74U and the surface 74L of one of the grooves 74 with the rib 118 and by the contact of the surface 74U and the surface 74L of one of the grooves 74 with the rib 119.

The outer surface of the front wall 53 of the cover 32 is a front surface 75. The front surface 75 is positioned frontward of the supply port 34. The front surface 75 has an upper front surface 75U positioned at an upper portion thereof and a lower front surface 75L positioned at a lower portion thereof. The upper end of the lower front surface 75L is continuous with the upper front surface 75U. The lower end of the lower front surface 75L is positioned rearward of the upper end of the lower front surface 75L, and the lower front surface 75L is inclined upward as the lower front surface 75L extends toward the front. The lower front surface 75L is a guide for guiding the rib 118 and the rib 119 into the groove 74. Specifically, in the process in which the ink cartridge 30 is inserted into the case 110, the lower front surface 75L comes into contact with the front end of the rib 118 and the front end of the rib 119. In this configuration, the lower front surface 75L guides each of the rib 118 and the rib 119 to the groove 74.

The upper front surface 75U of the front wall 53 of the cover 32 has a through hole 76. The valve 50 of the container body 31 is exposed to the outside through the through hole 76. The front end of the through hole 76 is positioned frontward of the supply port 34 of the supply portion 33.

The lower surface 70 of the cover 32 has a first key portion 77. The first key portion 77 is positioned above the supply port 34 and below the upper surface of the electrode 61 of the IC board 60. The front end of the first key portion 77 is positioned frontward of the front end of the electrode 61. The first key portion 77 is positioned below the through hole 76. In other words, the atmosphere communication port 501 defined by the front end of the atmosphere communication portion 502 is positioned between the first key portion 77 and the electrode 61 in the up-down direction. The first key portion 77 is positioned at a front part of the ink cartridge 30.

As shown in FIG. 8, the first key portion 77 is positioned between the pair of walls 71 in the left-right direction and extends downward from the lower surface 70. A rear end of the wall 71 is continuous with the sub-front wall 88. A rear end of the first key portion 77 is continuous with the sub-front wall 88. The first key portion 77 has a lower surface 77L defining a lower end of the first key portion 77, side surfaces 77S, and a front surface 77F defining a front end of the first key portion 77. Each of the side surfaces 77S of the first key portion 77 extends along the up-down direction and the front-rear direction.

The lower surface 77L of the first key portion 77 extends along the front-rear direction and left-right direction. The lower surface 77L defines the width of the first key portion 77 in the left-right direction. In the present embodiment, the first key portion 77 has a plate shape in which the length in the front-rear direction is greater than the length in each of the left-right direction and the length in the up-down direction, however the shape of the first key portion 77 is not limited thereto. For example, the length of the first key portion 77 in the front-rear direction may be smaller than the length thereof in the up-down direction. The lower surface 77L is a position overlapping at least one of the electrodes 61 in the up-down direction. In other words, the lower surface 77L is positioned directly below at least one of the electrodes 61 in the up-down direction. As shown in FIG. 5, the length L1 of the lower surfaces 77L in the front-rear direction is greater than the length L2 of the upper surface of the electrodes 61 in the front-rear direction. The front surface 77F of the first key portion 77 faces frontward. The front surface 77F is positioned rearward of the front end of the first front surface 72 of the wall 71. The first front surface 72 is positioned rearward of the front end of the second front surface 73. Further, the front surface 77F of the first key portion 77 is positioned rearward of the front end of the front wall 53 of the cover 32. Thus, in a case where the ink cartridge 30 is dropped with the front wall 53 of the cover 32 facing downward, even when the first front surface 72 or the second front surface 73 of the wall 71 or the front end of the front wall 53 of the cover 32 collides with a floor or the like, the front surface 77F of the first key portion 77 does not collide with the floor or the like. Therefore, the first key portion 77 is less likely to be deformed by a direct impact. On a related note, as will be described later, the first key portion 77 functions as a key to ensure that the ink cartridge 30 is attached to the right slot 108. When the first key portion 77 is deformed, the first key portion 77 may not correctly function as a key.

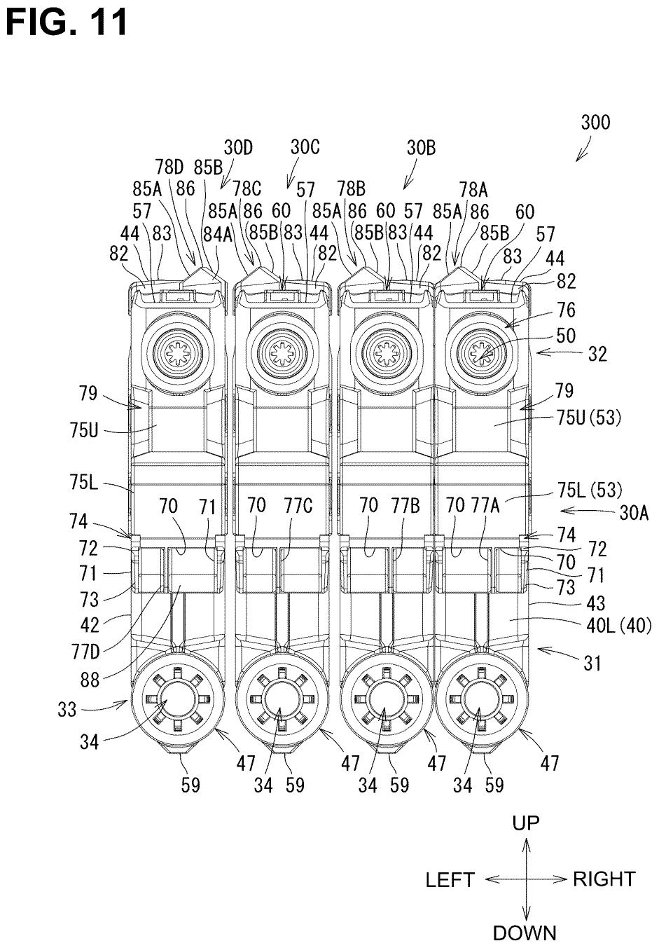

As shown in FIG. 11, the first key portions 77 are assigned to the respective slots 108A, 108B, 108C, and 108D in accordance with the characteristics of the ink cartridges 30 to be mounted. The mechanical characteristics of the first key portion 77 such as the arrangement and the shape are different. The position of the first key portion 77 in the left-right direction varies depending on the characteristics of the ink stored in the chamber 46. The characteristics of the ink are, for example, the color and composition of the ink.

The cover 32 includes a third key portion 79. The third key portion 79 is defined by a recessed portion recessed from the left wall 54 of the cover 32, a recessed portion recessed from the right wall 55, a convex portion protruding leftward from the left wall 54, or a convex portion protruding rightward from the right wall 55. In the present embodiment, the third key portion 79 includes a recessed portion that is recessed from the left wall 54 of the cover 32 and a recessed portion that is recessed from the right wall 55. As shown in FIG. 8, the third key portion 79 is a combination of the recessed portion of the left wall 54 and the recessed portion of the right wall 55. The third key portion 79 is positioned above the first key portion 77 and below the upper surface of the electrode 61 of the IC board 60. In this embodiment, the third key portion 79 is positioned below the through hole 76. The third key portion 79 is positioned at both ends of the upper front surface 75U in the left-right direction. The front end of the third key portion 79 is opened frontward in the upper front surface 75U of the cover 32. That is, both of the recessed portion of the left wall 54 and the recessed portion of the right wall 55 are opened frontward in the upper front surface 75U of the cover 32.

Depending on the characteristic of each ink cartridge 30, the mechanical characteristic such as the position and shape of the third key portion 79 is different. The characteristic of the ink cartridge 30 indicated by the third key portion 79 may be the same as or different from the characteristic of the ink cartridge 30 indicated by the first key portion 77. In the present embodiment, the characteristic of the ink cartridge 30 indicated by the first key portion 77 is the color of the ink, and the characteristic of the ink cartridge 30 indicated by the third key portion 79 is the type of contract that a user will enter into when using a printer in which the ink cartridge 30 is used. The type of contract may include a contract in which a user is charged in accordance with the number of pages on which image recording is performed regardless of the amount of ink used. As long as this contract is concluded, a new ink cartridge 30 is delivered when the ink in the chamber 46 of the ink cartridge 30 is consumed, but the user does not have to pay for the ink cartridge 30 itself. Alternatively, the characteristic of the ink cartridge 30 indicated by the third key portion 79 is a sales area of the printer in which the ink cartridge 30 is used. The shape of the third key portion 79 of the ink cartridge 30 used in a certain sales area is different from the shape of the third key portion 79 of the ink cartridge 30 used in another sales area. For example, the third key portion 79 may be disposed only on one of the left and right sides, or the shape of the third key portion 79 opening frontward may be different depending on the contract type or the sales area. The presence or absence and the shape of the fitting piece 122 and the fitting piece 123 of the cartridge case 110 are different in accordance with the presence or absence and the shape of the third key portion 79.

As shown in FIG. 9, the container body 31 has a rear surface 62 as an outer surface of the rear wall 41 of the container body 31. The rear surface 62 includes a first rear surface 63, a second rear surface 64, and a third rear surface 65. The second rear surface 64 is positioned on the left of the first rear surface 63. The third rear surface 65 is positioned on the right of the first rear surface 63. The first rear surface 63 is a flat surface orthogonal to the front-rear direction. The second rear surface 64 is a plane intersecting with the front-rear direction and the right-left direction. The right end of the second rear surface 64 is continuous with the first rear surface 63. The left end of the second rear surface 64 is positioned leftward and rearward of the first rear surface 63. The third rear surface 65 is a plane intersecting with the front-rear direction and the left-right direction. The left end of the third rear surface 65 is continuous with the first rear surface 63. The right end of the third rear surface 65 is positioned rightward and rearward of the first rear surface 63. The length of the first rear surface 63 in the left-right direction is constant in the up-down direction.

As shown in FIGS. 4, 5 and 9, the lower wall 45 of the container body 31 includes a first lower wall 45A and a second lower wall 45B. A rear end of the first lower wall 45A is continuous with a lower end of the rear wall 41. A front portion of the first lower wall 45A extends in the front-rear direction. A front end of the first lower wall 45A is continuous with the front wall 40. The supply portion 33 is positioned on the first lower wall 45A. The curved front surface of the supply portion 33 including the rear end of the supply portion 33 protrudes downward from the first lower wall 45A.

The second lower wall 45B is continuous with the lower end of the rear wall 41. The second lower wall 45B is an inclined wall inclined with respect to the front-rear direction. The second lower wall 45B is inclined with respect to the front-rear direction and the up-down direction such that an upper end of the second lower wall 45B is positioned rearward and upward of a lower end thereof. The lower end of the second lower wall 45B is continuous with the rear end of the lower surface 47 of the supply portion 33. The lower end of the second lower wall 45B is continuous with the rear end of the supply portion 33 in a position below the first lower wall 45A. The second lower wall 45B is shorter than the first lower wall 45A in the left-right direction.

Since the supply portion 33 is positioned below the first lower wall 45A, as shown in FIG. 9, the lower surface 47 of the supply portion 33 is visible when the ink cartridge 30 is viewed from the rear. Therefore, it is possible for the user to recognize where the supply portion 33 is when viewed from the rear, and it is easy to attach the ink cartridge 30 in the correct orientation when the ink cartridge 30 is attached to the slot 108. In addition, since the lower wall 45 is continuous with the rear end of the supply portion 33, the rear end of the supply portion 33 is reinforced. As a result, even if the lower end of the ink cartridge 30 receives an impact, the supply portion 33 is less likely to be deformed. Note that the lower wall 45 may have only the first lower wall 45A without the second lower wall 45B.

The second rear surface 64 has a recess 66 near the upper end. The recess 66 is constituted by a space recessed frontward from the second rear surface 64 and a surface defining the space. The third rear surface 65 has a recess 67 near the upper end. The recess 67 is constituted by a space recessed frontward from the third rear surface 65 and a surface defining the space. As shown in FIG. 1, a protrusion 127 protruding from the cover 126 is accommodated in each of the recesses 66 and 67 when the cover 126 is closed. The protrusion 127 of the cover 126 in the closed state is in contact with the surface forming the upper end of the recesses 66 and 67. With this configuration, the ink cartridge 30 attached to the cartridge case 110 is less likely to be detached from the cartridge case 110 due to an impact or the like. Further, as shown in FIG. 9, a length in the left-right direction of the first rear surface 63 sandwiched between the recess 66 and the recess 67 is greater than a length in the left-right direction of the recess 66 and greater than a length in the left-right direction of the recess 67. Thus, since the first rear surface 63 is easily visible from the rear of the ink cartridge 30, the user is more likely to press an upper portion of the first rear surface 63 when attaching the ink cartridge 30 to the cartridge case 110.

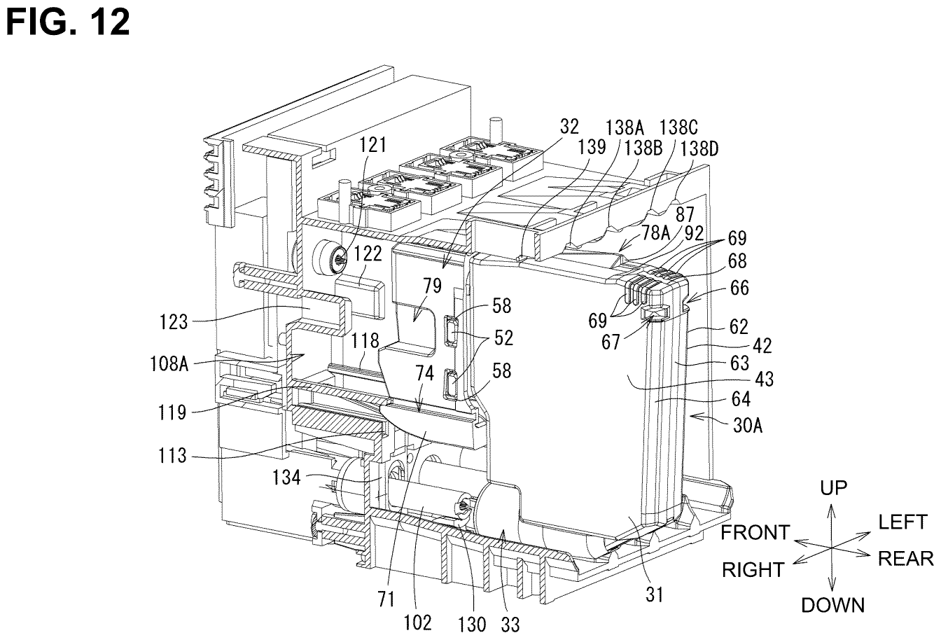

As shown in FIGS. 9 and 10, the rear end of the upper surface 80 of the upper wall 44 of the container body 31 includes an operation surface 68. The operation surface 68 is an inclined surface inclined so as to face upward and rearward. The operation surface 68 is continuous with the upper end of the rear surface 62. The operation surface 68 has a plurality of protrusions 69 that protrude upward and extend along the left-right direction. As shown in FIG. 12, the protrusions 69 extend downward from both ends of the operation surface 68 in the left-right direction so as to reach the outer surfaces of the left wall 42 and the right wall 43. Three protrusions 69 extend from the left end of the operation surface 68 to the left wall 42 so as to be spaced apart in the front-rear direction. Three protrusions 69 extend from the right end of the operation surface 68 to the right wall 43 so as to be spaced apart in the front-rear direction. The protrusions 69 function as a slip stopper when the user operates the operation surface 68. Note that the slip stopper may be, for example, a recess recessed downward from the operation surface 68 instead of the protrusion 69.

The upper surface 80 of the container body 31 includes a first upper surface 81, a second upper surface 82, a third upper surface 83, an upper end surface 86, and the operation surface 68.

The first upper surface 81 is positioned at a front end of the upper surface 80. As shown in FIGS. 3 and 6, the first upper surface 81 has a surface 81A positioned at the center in the left-right direction, a surface 81B positioned on the left, and a surface 81C positioned on the right. The surface 81A is a plane orthogonal to the up-down direction. The surface 81B is continuous with the left end of the surface 81A. The surface 81C is continuous with the right end of the surface 81A. The surface 81B is a surface facing upward and leftward. The surface 81C is a surface facing upward and rightward. The length of the surface 81A in the left-right direction is smaller than the length of the surface 81B in the left-right direction. The length of the surface 81A in the left-right direction is smaller than the length of the surface 81C in the left-right direction.

The second upper surface 82 is continuous with the rear end of the first upper surface 81. The rear end of the second upper surface 82 is positioned higher than the front end thereof. The second upper surface 82 has a surface 82A positioned at the center in the left-right direction, a surface 82B positioned on the left of the surface 82A, and a surface 82C positioned on the right of the surface 82A. As shown in FIGS. 5 and 10, the surface 82A is inclined with respect to the front-rear direction so as to face frontward and upward. The surface 82A is a flat surface extending in the front-rear direction and the left-right direction. The surface 82A faces upward and frontward. The surface 82B is continuous with the left end of the surface 82A and faces leftward. The surface 82C is continuous with the right end of the surface 82A and faces rightward. The length of the surface 82A in the left-right direction is smaller than the length of the surface 82B in the left-right direction. The length of the surface 82A in the left-right direction is smaller than the length of the surface 82C in the left-right direction. The length of the surface 82A in the left-right direction is equal to the length of the surface 81A in the left-right direction. The length of the surface 82A in the front-rear direction is greater than the length of the surface 81A in the front-rear direction.

The third upper surface 83 is continuous with the rear end of the surface 82C of the second upper surface 82. The third upper surface 83 is a plane orthogonal to the up-down direction. The third upper surface 83 is positioned above the first upper surface 81. A rear end of the third upper surface 83 is continuous with the operation surface 68. The third upper surface 83 has a contact surface 92. The contact surface 92 extends rearward from a lower end of a locking surface 87 of a second key portion 78 described later.

As shown in FIGS. 5 and 6, the second key portion 78 is positioned on the third upper surface 83 of the container body 31. The second key portion 78 protrudes upward from the third upper surface 83. The second key portion 78 is positioned above the supply port 34. An upper end of the second key portion 78 is positioned above the upper surface of the electrode 61 of the IC board 60. The second key portion 78 is positioned rearward of the IC board 60 in the front-rear direction. The second key portion 78 is positioned frontward of the operation surface 68. When the protrusion 52 of the container body 31 is in contact with the upper end of the through hole 58 of the cover 32, the cover 32 is positioned at the lowest position with respect to the container body 31. In a state where the cover 32 is positioned at the lowest position with respect to the container body 31, the upper end of the second key portion 78 is positioned above the IC board 60.

The second key portion 78 has a first frontward inclined surface 84A, a second frontward inclined surface 84B, a left inclined surface 85A, a right inclined surface 85B, an upper end surface 86, and a locking surface 87. The first frontward inclined surface 84A is a flat surface and is inclined such that a distance with regard to the supply port 34 in the up-down direction gradually increases from a front end of the second key portion 78 toward a rear end of the second key portion 78. The first frontward inclined surface 84A is continuous with the rear end of the surface 82B of the second upper surface 82. The second frontward inclined surface 84B is a flat surface inclined with respect to the front-rear direction so as to face upward and frontward. The second frontward inclined surface 84B extends leftward as the second frontward inclined surface 84B extends rearward from the front end thereof. The rear end of the second frontward inclined surface 84B is continuous with the upper end surface 86. The front end of the second frontward inclined surface 84B is continuous with the rear end of the surface 82A of the second upper surface 82. The lower end of the second frontward inclined surface 84B is continuous with the third upper surface 83. The left end of the second frontward inclined surface 84B is continuous with the right end of the first frontward inclined surface 84A. A boundary between the first frontward inclined surface 84A and the second frontward inclined surface 84B extends leftward from the front end toward the rear. An upper end of the boundary between the first frontward inclined surface 84A and the second frontward inclined surface 84B is continuous with the upper end surface 86. An internal space 231 defined by the first forward inclined surface 84A, the second forward inclined surface 84B, the left inclined surface 85A, the right inclined surface 85B, the upper end surface 86, and the lock surface 87 communicates with the chamber 46. The second key portion 78 is an example of a protruding portion.

The upper end surface 86 is a flat surface facing upward. An upper end of the locking surface 87 is continuous with a rear end of the upper end surface 86. In other words, the upper end surface 86 is positioned between the second frontward inclined surface 84B and the locking surface 87 in the front-rear direction. The locking surface 87 is a flat surface facing rearward. In the attached state where the ink cartridge 30 is attached to the cartridge case 110, the locking surface 87 and the contact surface 92 are in contact with the locking portion 139 of the cartridge case 110.

The left inclined surface 85A is a flat surface inclined with respect to the left-right direction so as to extend upward from the left end toward the right end. The left inclined surface 85A is continuous with a left end of the first frontward inclined surface 84A. A boundary between the left inclined surface 85A and the first frontward inclined surface 84A extends rightward from the front end toward the rear end. A rear end of the boundary between the left inclined surface 85A and the first frontward inclined surface 84A is continuous with the upper end surface 86. The upper end of the left inclined surface 85A is continuous with the upper end surface 86. The rear end of the left inclined surface 85A is continuous with the locking surface 87. The right inclined surface 85B is a flat surface that is inclined with respect to the left-right direction so as to extend upward from the right end toward the left end. The right inclined surface 85B is continuous with the right end of the second frontward inclined surface 84B. A boundary between the right inclined surface 85B and the second frontward inclined surface 84B extends leftward from the front end toward the rear end. A rear end of the boundary between the right inclined surface 85B and the second frontward inclined surface 84B is continuous with the upper end surface 86. The rear end of the right inclined surface 85B is continuous with the locking surface 87. Since the second key portion 78 has the first frontward inclined surface 84A, the second frontward inclined surface 84B, the left inclined surface 85A, and the right inclined surface 85B, the strength of the second key portion 78 is higher than in a case where the second key portion 78 has a surface extending in the up-down direction. Therefore, the second key portion 78 is not easily deformed by an impact from the right and left direction.

As shown in FIGS. 5 and 8, a first angle θ1 formed between the second frontward inclined surface 84B and a horizontal plane is smaller than a second angle θ2 formed between the left inclined surface 85A and a horizontal plane. A third angle θ3 formed between the right inclined surface 85B and a horizontal plane may be different from the second angle θ2 formed between the left inclined surface 85A and a horizontal plane. The first angle θ1 is, for example, within a range of 5° to 10°, and is 7° in the present embodiment. The second angle θ2 is, for example, within a range of 30° to 40°. The third angle θ3 is, for example, within a range of 30° to 40°.

The mechanical characteristics of the second key portion 78, such as the arrangement and shape, differ depending on the characteristics of each ink cartridge 30. The characteristics indicated by the second key portion 78 may be the same as or different from the characteristics indicated by the first key portion 77 and the third key portion 79. In the present embodiment, the characteristic of the ink cartridge 30 indicated by the second key portion 78 is the composition of the ink. The position of the second key portion 78 in the left-right direction on the second upper surface 82 varies depending on the composition of the ink. The composition of the ink means a material contained in the ink, for example, whether a coloring material contained in the ink is a black dye or a black pigment.

As shown in FIG. 8, a length M1 of the first key portion 77 in the left-right direction is smaller than a length M2 of the second key portion 78 in the left-right direction, that is, a maximum width of the second key portion 78 in the left-right direction. As shown in FIG. 5, a length M3 of the front end of the first key portion 77 in the up-down direction is greater than the length M4 of the second key portion 78 in the up-down direction, that is, a maximum height of the second key portion 78 in the up-down direction. The length M4 corresponds to a length of the locking surface 87 of the second key portion 78 in the up-down direction. The maximum height of the second key portion 78 in the up-down direction is less than the maximum width of the second key portion 78 in the left-right direction.

As shown in FIG. 5, a first distance N1, which is the shortest distance between the center of the supply port 34 and the first key portion 77, is smaller than a second distance N2, which is the shortest distance between the center of the supply port 34 and the second key portion 78. With such a configuration, as will be described later, when the rear end of the container body 31 is rotated upward about the supply port 34, the length of the trajectory of rotation of the first key portion 77 is smaller than the length of the trajectory of rotation of the second key portion 78.

As shown in FIG. 11, an ink cartridge set 300 includes a plurality of ink cartridges 30. The ink cartridges 30 included in the ink cartridge set 300 have different mechanical characteristics such as the position and/or the shape of the first key portion 77, the second key portion 78, and the third key portion 79 depending on the difference in the characteristics of the ink cartridges 30. The positions of the first key portions 77 of the four ink cartridges 30 in the left-right direction are different depending on the colors of the inks stored in the ink cartridges 30. The positions of the second key portions 78 of the four ink cartridges 30 in the left-right direction are different depending on the compositions of the inks stored in the ink cartridges 30. In this specific embodiment, the composition of the ink means whether the ink contains a dye or a pigment. The positions and/or shapes of the third key portions 79 of the four ink cartridges 30 are different depending on the sales areas of the printers in which the cartridges 30 are used. The ink cartridge 30A in FIG. 11 corresponds to the ink cartridge 30 illustrated in FIGS. 3 to 10.

The position of the first key portion 77 in the left-right direction corresponds to the position of the first key slot 115 of the cartridge case 110. The first key portion 77 of the ink cartridge 77A, which is positioned on the rightmost side in FIG. 11, is positioned to the right of the center of the ink cartridge 30A in the left-right direction on the lower surface 70. The ink cartridge 30A stores a magenta ink which contains a dye as a coloring agent. The first key portion 77B of the ink cartridge 30B, which is positioned second from the right in FIG. 11, is positioned further to the left than the first key portion 77A of the ink cartridge 30A in the left-right direction on the lower surface 70. The ink cartridge 30B stores a cyan ink which contains a dye as a coloring agent. The first key portion 77C of the ink cartridge 30C, which is positioned third from the right in FIG. 11, is positioned further to the left than the first key portion 77B of the ink cartridge 30B in the left-right direction on the lower surface 70. The ink cartridge 30C stores a yellow ink which contains a dye as a coloring agent. The first key portion 77D of the ink cartridge 30D, which is positioned on the leftmost side in FIG. 11, is positioned further to the left than the first key portion 77C of the ink cartridge 30C in the left-right direction on the lower surface 70. The ink cartridge 30D stores a black ink which contains a pigment as a coloring agent.

The positions in the left-right direction of the second key portions 78A, 78B, 78C, and 78D of the ink cartridges 30A, 30B, 30C, and 30D correspond to the positions of the respective second key slots 138 of the cartridge case 110. Each of the second key portions 78A, 78B, and 78C of the ink cartridges 30A, 30B, and 30C is positioned further leftward than the center of the second upper surface 82 in the left-right direction. The second key portion 78D of the ink cartridge 30D is positioned to the right of the center of the second upper surface 82 in the left-right direction. In the present embodiment, since the four ink cartridges 30 shown in FIG. 11 are used in the same sales area, the positions and shapes of the third key portions 79 are the same.

### [Attachment of Ink Cartridge 30 to Cartridge Case 110]

As shown in FIG. 12, the ink cartridge 30 is inserted into a predetermined slot 108 of the cartridge case 110 in the frontward direction. In other words, the ink cartridge 30 is inserted such that the front wall 53 of the ink cartridge 30 faces the end surface 103 of the case body 101. The ink cartridges 30A, 30B, 30C, and 30D storing magenta, cyan, yellow, and black inks, respectively are inserted into the four slots 108A, 108B, 108C, and 108D, respectively. Hereinafter, an example in which an ink cartridge 30A storing magenta ink is inserted into the rightmost slot 108A in the left-right direction will be described. The ink cartridge 30A storing magenta ink is positioned at the rightmost position in FIG. 11. The user pushes the first rear surface 63 of the ink cartridge 30A frontward with the finger and inserts the ink cartridge 30A frontward into the cartridge case 110.

As shown in FIGS. 13A and 13B, the ink cartridge 30A is inserted into the slot 108A through the opening 112 of the case body 101. The lower surface 47 of the inserted ink cartridge 30A is supported by the guide surface 161 of the case body 101 shown in FIG. 2.

Before the supply port 34 of the ink cartridge 30A reaches the supply tube 102, the second key portion 78A reaches a position directly below the second key slot 138A of the case body 101. The second key portion 78A of the ink cartridge 30A is positioned on the left with respect to the center of the second upper surface 82 in the left-right direction. On the other hand, the second key slot 138A is positioned on the left with respect to the center of the slot 108A in the left-right direction. Therefore, when the ink cartridge 30A is further inserted frontward, as shown in FIGS. 14A and 14B, the second key portion 78A moves directly below the second key slot 138A. When this occurs, the second frontward inclined surface 84B of the second key portion 78A comes into contact with the locking portion 139, whereby a downward force is applied to the ink cartridge 30A. When the downward force is applied to the second frontward inclined surface 84B of the second key portion 78A, the ink cartridge 30A rotates clockwise as shown in FIGS. 14A and 14B. As a result, the lower surface 47 of the supply portion 33 which defines the lower end of the ink cartridge 30A comes into contact with the guide surface 161 of the case body 101, and the second key portion 78A moves frontward while coming into contact with the locking portion 139.

Further, the first key portion 77A enters the first key slot 115A in a state where the supply portion 33 is in contact with the guide surface 161 of the case body 101 and the second frontward inclined surface 84B of the second key portion 78A is in contact with the locking portion 139.

Further, one of the pair of walls 71 enters the groove 113. The other one of the pair of walls 71 enters the groove 114. Further, the rib 118 enters one of the two grooves 74. The rib 119 enters the other one of the two grooves 74. One of the pair of walls 71 enters the groove 113, and the other enters the groove 114, whereby the cover 32 is guided frontward. When the rib 118 enters one of the two grooves 74 and the rib 119 enters the other one of the two grooves 74, the cover 32 is positioned with respect to the cartridge case 110 in the up-down direction. In other words, the position of the cover 32 with respect to the cartridge case 110 in the up-down direction is determined.

The second front surface 73 of the one of the pair of walls 71 moves frontward while being in contact with the lower surface of the groove 113 and the second front surface 73 of the other one of the pair of walls 71 moves frontward while being in contact with the lower surface of the groove 114, whereby one of the walls 71 is guided into the groove 113 and the other is guided into the groove 114 in the up-down direction. Further, when the first front surface 72 of one of the walls 71 or the lower front surface 75L of the cover 32 comes in contact with the rib 118 as the ink cartridge 30A moves frontward, the rib 118 is guided into the groove 74 in the up-down direction. When the first front surface 72 of the other one of the walls 71 or the lower front surface 75L of the cover 32 comes in contact with the rib 119 as the ink cartridge 30A moves frontward, the rib 119 is guided into the groove 74 in the up-down direction. In addition, when the first key portion 77A of the ink cartridge 30A enters the first key slot 115A, the side surfaces 77S of the first key portion 77A shown in FIGS. 4 and 8 moves frontward while being into contact with the pair of protruding pieces 117, and thus the first key portion 77A is guided into the first key slot 115A in the left-right direction.

While the first key portion 77A of the ink cartridge 30A enters the first key slot 115A, the second key portion 78A enters the second key slot 138A. In addition, while the second key portion 78A enters the second key slot 138A, the second frontward inclined surface 84B and the upper end surface 86 sequentially come into contact with the locking portion 139. As shown in FIGS. 14A and 14B, a downward and rearward force acts on the container body 31 in a state where the second frontward inclined surface 84B is in contact with the locking portion 139, and a downward force acts on the container body 31 in a state where the upper end surface 86 is in contact with the container body 31. When the second frontward inclined surface 84B or the upper end surface 86 slides on the locking portion 139, the lower surface 47 of the container body 31 slides on the guide surface 161.

When the first key portion 77A of the ink cartridge 30A enters the first key slot 115A, the lower surface 77L of the first key portion 77A comes into contact with the upper end 136 of the pressing plate 134. When the first key portion 77A of the ink cartridge 30A enters the first key slot 115A, the lower surface 77L of the first key portion 77A presses the pressing plate 134 downward to move the ink receiving member 130 from the first position to the second position. When this occurs, an upward force originated from the urging, i.e., pulling force of the coil spring 133 acts on the cover 32 via the ink receiving member 130 and the pressing plate 134, but the surfaces 74L and 74U of the groove 74 shown in FIG. 8 is in contact with the rib 118, whereby the cover 32 is positioned with respect to the cartridge case 110 in the up-down direction. As a result, the cover 32 does not move upward. The pressing plate 134 moves downward against the urging force of the coil spring 133. When the pressing plate 134 moves downward, the ink receiving member 130 moves from the first position shown in FIGS. 13A and 13B to the second position shown in FIGS. 14A and 14B.

When the ink receiving member 130 is in the second position, the supply port 34 is connected to the supply tube 102 as the ink cartridge 30A moves frontward. In response to the supply tube 102 pushing the first valve 36A, the first valve 37A moves rearward from the closed position toward the open position against the urging force of the first coil spring 36A. As the first valve 36A moves rearward, the first coil spring 37A is compressed in the front-rear direction, thereby the biasing force of the first coil spring 37A increases. When the urging force of the first coil spring 37A becomes stronger than the urging force of the second coil spring 37B, the second valve 36B moves rearward from the closed position toward the open position. Thus, the internal space of the lower support member 11 and the internal space of the supply tube 102 communicate with each other. As a result, the ink in the chamber 46 is supplied to the sub-tank 120 through the through hole 206, the internal space of the lower support member 11, and the internal space of the supply tube 102. The outer peripheral surface of the supply tube 102 connected to the supply portion 33 is in contact with the seal member 35 so as not to leak the ink.

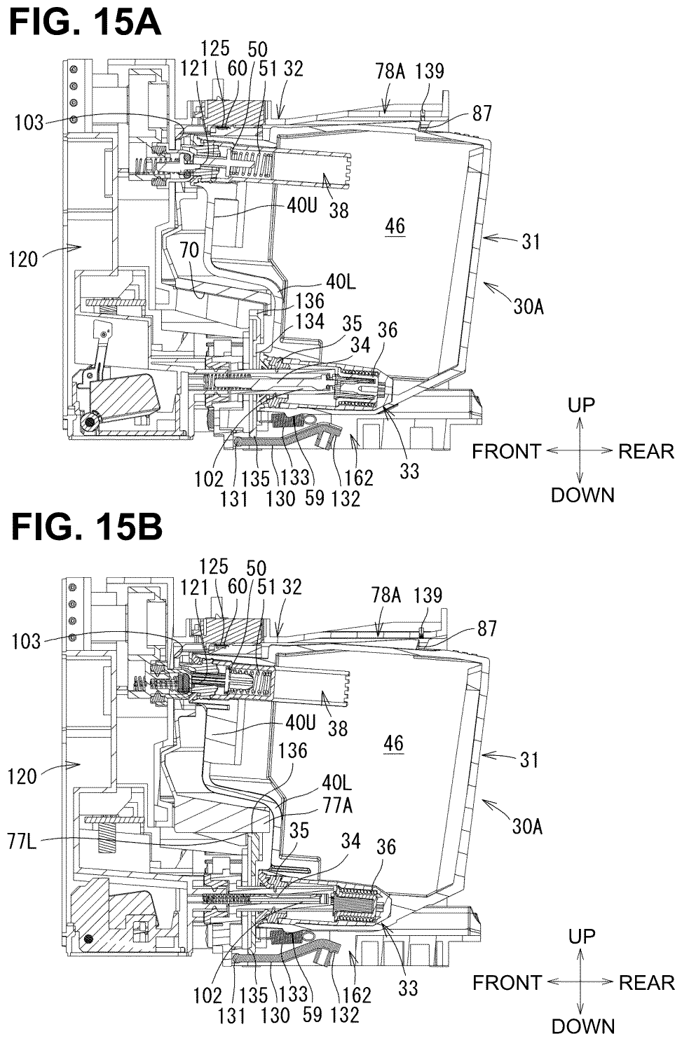

As shown in FIGS. 15A and 15B, as the ink cartridge 30A moves frontward, the rod 121 of the slot 108A comes into contact with the valve 50 of the atmosphere communication portion 502 through the opening of the cover 32. The rod 121 pushes the valve 50, and the valve 50 moves rearward against the urging force of the coil spring 51. When the valve 50 moves rearward, the atmosphere communication opening 501 is opened to allow air to flow between the outside and the chamber 46. Further, the electrodes 61 of the IC board 60 comes into contact with the contacts 125 and are electrically connected to the contacts 125. Further, the locking surface 87 of the second key portion 78A is positioned frontward of the locking portion 139. The contact surface 92 is positioned directly below the locking portion 139.

The contacts 125 are elastically deformable like a leaf spring, the contacts 125 apply a downward contact pressure to the electrodes 61 when the electrodes 61 contact the contacts 125. Further, the biasing force of the coil spring 133 indirectly acting upward on the cover 32. Although the contacts 125 apply the downward contact pressure to the electrodes 61 and the coil spring 133 applies the upward pressure to the first key portion 77A, the surface 74L or 74U of the grooves 74 absorbs the upward or downward pressure by the rib 118 and the rib 119 coming into contact with the surface 74L or 74U of the grooves 74. Accordingly, the force acting upward to the cover 32 and the force acting downward to the cover 32 are balanced.

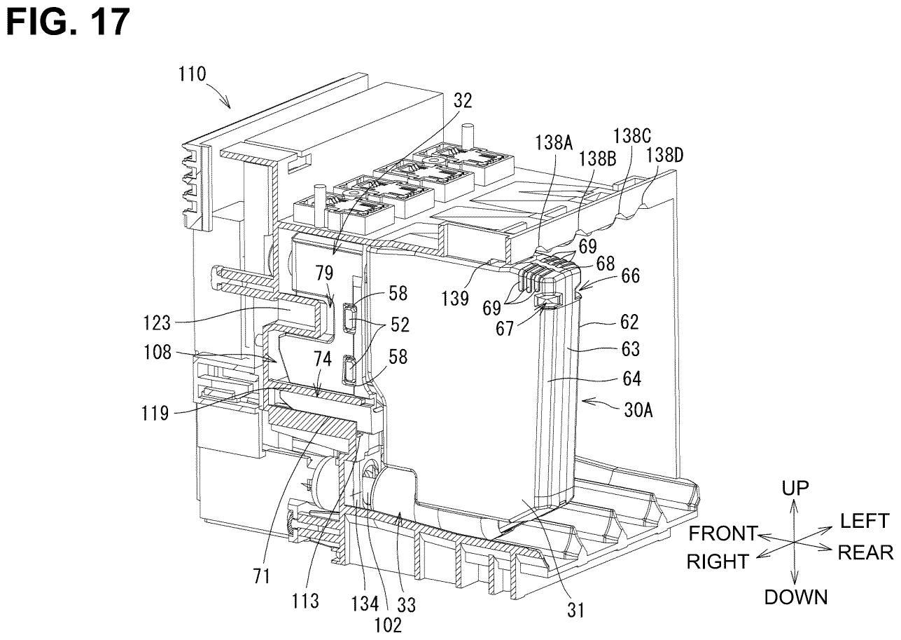

Further, as shown in FIG. 15B, the position in the front-rear direction at which the upper end 136 of the pressing plate 134 is in contact with the first key portion 77A is different from the position in the front-rear direction at which the contacts 125 are in contact with the electrodes 61. Specifically, the position in the front-rear direction at which the upper end 136 of the pressing plate 134 is in contact with the first key portion 77A is positioned frontward of the position in the front-rear direction at which the contacts 125 are in contact with the electrodes 61. As a result, a force acts on the cover 32 to rotate the cover 32 about a rotation axis extending in the left-right direction such that the rear end side of the cover 32 moves more upward than the front end side thereof. On the other hand, as shown in FIG. 17, the rib 118 and the rib 119 come into contact with the surfaces 74L, 74U of the grooves 74, whereby the rotation of the cover 32 is suppressed.

As shown in FIG. 17, when the ink cartridge 30A is inserted to be in the attached state in the slot 108A, the third key portions 79 matches with the fitting piece 122 and the fitting piece 123. It is assumed that an ink cartridge 30 which is sold in a different area, and which is not provided with one of the recessed portions of the third key portion 79 formed in the left wall 54 and the right wall 55 of the cover 32 is inserted into the slot 108D. In the slot 108D, the fitting piece 122 is positioned on the right side, and the fitting piece 123 is positioned on the left side. In the ink cartridge 30 in which one of the recessed portions of the third key portion 79 formed in the left wall 54 and the right wall 55 of the cover 32 is not provided, the front wall 53 of the cover 32 comes into contact with one of the fitting piece 122 and the fitting piece 123. Thus, the ink cartridge 30 cannot be further inserted into the slot 108D in the frontward direction. Since the ink cartridge 30 cannot be inserted into the slot 108D, it means that the ink cartridge 30 is identified as an ink cartridge 30 that is intended to be used in a printer sold in a sales area different from that of the printer 10.

In the state shown in FIGS. 15A and 15B, the container body 31 is rotatable around the supply port 34 such that the rear end thereof is to be moved downward and upward in a state where the container body 31 is inserted in the slot 108A. More specifically, the container body 31 is rotatable around an axis extending in the left-right direction and passing through the center of the supply port 34 so that the rear end side thereof moves upward in the slot 108A. Although the position of the cover 32 with respect to the cartridge case 110 in the up-down direction is determined as described before, because the through hole 58 of the cover 32 is sufficiently larger than the outer shape of the protrusion 52 of the container body 31, the container body 31 can rotate like this. When the ink cartridge 30A rotates so that the rear end side moves upward, the locking surface 87 of the second key portion 78A and the locking portion 139 face each other in the front-rear direction. When the user removes his/her fingers from the ink cartridge 30A, the ink cartridge 30A is moved rearward by the urging forces of the coil spring 37 and the coil spring 51, and the locking surface 87 comes into contact with the locking portion 139 as shown in FIGS. 16A and 16B. Accordingly, the ink cartridge 30A is held in the attached state. Further, the contact surface 92 comes into contact with the locking portion 139. As a result, the container body 31 of the ink cartridge 30A is positioned in the up-down direction with respect to the cartridge case 110. In other words, the position of the ink cartridge 30A with respect to the cartridge case 110 in the up-down direction is determined.

In a state where the ink cartridge 30A is held in the cartridge case 110, the internal space of the ink cartridge 30A communicates with the atmosphere through the internal space of the upper support member 38. As a result, the ink in the chamber 46 is supplied to the sub-tank 120 through the through hole 206, the internal space of the lower support member 11, and the internal space of the supply tube 102. Additionally, the air flows into the chamber 46 through the internal space of the upper support member 38. As the ink in the ink cartridge 30A moves to the sub-tank 120, the liquid level of the ink in the chamber 46 is lowered. When the liquid level of the ink in the chamber 46 is slightly lower than the upper end of the through hole 206 of the lower support member 11, the air in the ink cartridge 30A can move to the outside through the through hole 206, the internal space of the lower support member 11, the internal space of the supplying tube 102, and the internal space of the sub-tank 120, and thus the ink in the ink cartridge 30A is less likely to move to the sub-tank 120.

In addition, although the ink cartridge 30A is urged rearward by the first coil spring 37A, the second coil spring 37B, and the coil spring 51, the locking surface 87 of the ink cartridge 30A and the locking portion 139 of the cartridge case 110 come into contact with each other, and thus the rearward movement of the ink cartridge 30A is suppressed. As a result, the ink cartridge 30A is held in the cartridge case 110.

In addition, in the attached state where the ink cartridge 30A is held in the cartridge case 110, the electrodes 61 of the IC board 60 are in contact with the contacts 125. Further, the electrodes 61 are electrically connected to the contacts 125 so that the IC can communicate with the control unit of the printer 10 via the electrodes 61 and the contacts 125.

In addition, in the attached state of the ink cartridge 30A, the downward force which the electrodes 61 of the ink cartridge 30A receive from the contacts 125 is transmitted to the supply tube 102 which is inserted into the internal space of the supply portion 33. Since the downward force transmitted to the supply tube 102 is weakened by the upward counteracting force by the biasing force of the coil spring 133 via the pressing plate 134, it is possible to reduce the possibility that the supply tube 102 is deformed.

It is assumed that an ink cartridge 30 having the first key portion 77 at the same position as the ink cartridge 30A and the second key portion 78 at the same position as the ink cartridge 30D is inserted into the rightmost slot 108A of the cartridge case 110 shown in FIG. 2. In the rightmost slot 108A, the first key slot 115A is positioned on the right side of the slot 108A in the left-right direction, corresponding to the position of the first key portion 77 of the ink cartridge 30A. On the other hand, the second key slot 138A is positioned on the left side with respect to the center of the slot 108A in the left-right direction, corresponding to the position of the second key portion 78 of the ink cartridge 30A, not of the ink cartridge 30D. Therefore, since the second key portion 78 of this ink cartridge 30 and the second key slot 108A of the second key slot 138A are misaligned in the left-right direction, the upper end surface 86 comes into contact with the case body 101 before the second key portion 78 enters the second key slot 138A as the ink cartridge 30 rotates. As a result, since the locking surface 87 and the locking portion 139 do not face with each other in the front-rear direction, the ink cartridge 30A is not held in the slot 108D. Since the container body 31 cannot be rotated, the user understands that the ink cartridge 30 is not the ink cartridge 30 to be inserted into the slot 108A.

It is assumed that an ink cartridge 30 having the first key portion 77 at the same position as the ink cartridge 30A and the second key portion 78 at the same position as the ink cartridge 30D is inserted into the rightmost slot 108A of the cartridge case 110 shown in FIG. 2. In the rightmost slot 108A, the first key slot 115A is positioned on the right side of the slot 108A in the left-right direction, corresponding to the position of the first key portion 77 of the ink cartridge 30A. Therefore, the first key portion 77 of the ink cartridge 30 can enter the first key slot 115A. On the other hand, the second key slot 138A is positioned on the left side with respect to the center of the slot 108A in the left-right direction, corresponding to the position of the second key portion 78 of the ink cartridge 30A, not of the ink cartridge 30D. Therefore, since the second key portion 78 of this ink cartridge 30 and the second key slot 108A of the second key slot 138A are misaligned in the left-right direction, the upper end surface 86 comes into contact with the case body 101 before the second key portion 78 enters the second key slot 138A as the ink cartridge 30 rotates. As a result, since the locking surface 87 and the locking portion 139 do not face with each other in the front-rear direction, the ink cartridge 30A is not held in the slot 108D. Since the container body 31 cannot be rotated, the user understands that the ink cartridge 30 is not the ink cartridge 30 to be inserted into the slot 108A.

Next, the movement of the ink cartridge 30A, which is in the attached state where the ink cartridge 30A attached to the cartridge case 110, is detached and removed from the cartridge case 110 will be described. As shown in FIG. 17, in the attached state, the rib 118 and the rib 119, which are in contact with the grooves 74, restrict the up-down movement and rotation of the cover 32. Since the container body 31 is relatively movable with respect to the cover 32, only the container body 31 is rotatable around the supply port 34, more specifically, around the axis extending in the left-right direction and passing through the center of the supply port 34, even when the movement in the up-down direction and the rotation of the cover 32 are restricted. By the rotation of the container body 31, the locking surface 87 and the locking portion 139 selectively contact with each other and are separated from each other in the up-down direction.

In the attached state, when the user presses down the operation surface 68 of the container body 31 with a finger, the rear end side of the container body 31 moves downward. Thus, the locking surface 87 and the locking portion 139 are separated from each other in the up-down direction. When the user removes his/her finger from the operation surface 68, the ink cartridge 30 is moved rearward in the slot 108A by the urging forces of the coil spring 37 and the coil spring 51.

In the attached state, the convex portion 59 of the ink cartridge 30A is positioned in the space 162 of the case body 101. As the ink cartridge 30A moves rearward in the slot 108A, the convex portion 59 also moves rearward in the space 162, and the convex portion 59 comes into contact with the front end of the guide surface 161. As a result, the rearward movement of the ink cartridge 30A is restricted, and as shown in FIGS. 14A and 14B, the ink cartridge 30A does not jump out from the slot 108A, and stands still in a state where the front side of the ink cartridge 30A is positioned in the slot 108A. Further, as shown in FIGS. 13A and 13B, when the ink cartridge 30A moves rearward, the convex portion 59 of the ink cartridge 30A separates from the guide surface 161 of the slot 108A, and the ink cartridge 30A is taken out from the slot 108A.

### [Operation and Effect of Present Embodiment]

In the ink cartridge 30, the container body 31 is integrally formed by blow molding, and therefore, the number of components is small. The transfer surface 116 with which the first protrusion 302 and the second protrusion 303 come into contact is a portion to which the shape of the outer peripheral surface 212A of the blow pin 212 is transferred, and thus has a smaller dimensional tolerance than a portion other than the transfer surface 116 in the inner peripheral surface 33A. Therefore, a gap due to a dimensional error is unlikely to be formed between the first protrusion 302 and the transfer surface 116 and between the second protrusion 303 and the transfer surface 116, and thus the ink in the ink cartridge 30 is less likely to leak to the outside through the gap between the first protrusion 302 and the transfer surface 303 and between the second protrusion and the transfer surface 310. Since the first protrusion 302 and the second protrusion 303 is in contact with the transfer surface 116 having a small dimensional error, the position of the seal member 35 with respect to the valve 36 is unlikely to be shifted. Therefore, in a state where the third protrusion 304 and the rear end 111 of the rear portion 35B is in contact with the valve 36, a gap is unlikely to be formed between the third protrusion 304 and the valve 36 and the rear end 111 of the rear portion 35B and the valve 36. Therefore, the ink is less likely to leak to the outside through a portion between the third protrusion 304 and the valve 36 and a portion between the rear end 111 of the rear portion 35B and the valve 36.

In the ink cartridge 30, when the container body 31 is blow molded, the transfer surface 116 is formed by using the outer peripheral surface 212A of the blow pin 212 as a mold. Therefore, the container body 31 is molded more quickly than in a case where a mold for molding the transfer surface 116 is used separately from the blow pin 212.

In the ink cartridge 30, the front end portion 11A of the lower support member 11 is in contact with the seal member 35, and therefore, the position of the seal member 35 is determined more accurately. Therefore, the seal member 35 can easily be brought into contact with the transfer surface 116. Since the valve 36 and the biasing member 37 are supported by the inner peripheral surface 33A of the lower support member 11 which is an injection-molded product, the valve 36 and the biasing member 37 are maintained in a stable posture as compared with a case where the lower support member 11 is omitted.

In the ink cartridge 30, the front end portion 11A of the lower support member 11 is in contact with the seal member 35 in the frontward direction. Therefore, the position of the seal member 35 is determined more accurately in the front-rear direction. Therefore, the seal member 35 can easily be brought into contact with the transfer surface 116.

In the ink cartridge 30, the front end portion 11A of the lower support member 11 is in contact with the outer peripheral surface 305 of the rear portion 35B, and therefore the position of the seal member 35 is determined more accurately in the direction orthogonal to the front-rear direction. Therefore, the position of the seal member 35 with respect to the valve 36 is unlikely to be displaced in a direction orthogonal to the front-rear direction.

In the ink cartridge 30, the cap 39 is in contact with the inner peripheral surface 306 of the front portion 35A, and therefore the position of the seal member 35 is determined more accurately in the direction orthogonal to the front-rear direction. Therefore, the first protrusion 302 and the second protrusion 303 are easily held in a state of being in contact with the transfer surface 116.

In the ink cartridge 30, the cap 39 is in contact with the seal member 35 in the rearward direction, and therefore, the position of the seal member 35 is determined more accurately in the front-rear direction.

In the ink cartridge 30, the cap 39 is bonded or welded to the transfer surface 116 having a small dimensional tolerance, and thus is firmly fixed to the inner peripheral surface 33A of the supply portion 33.

In the ink cartridge 30, the second coil spring 37B is guided in the front-rear direction by the inner peripheral surface 202A of the reduced diameter portion 202 of the lower support member 11. Therefore, the posture of the second coil spring 37B is less likely to be inclined.

In the ink cartridge 30, the second valve 36B is guided in the front-rear direction by the inner peripheral surface 97 of the cylindrical portion 201 of the lower support member 11. Therefore, the posture of the second valve 36B is less likely to be inclined.

In the ink cartridge 30, the inner peripheral surface 97 of the cylindrical portion 201 of the lower support member 11 is a single surface from the front end to the rear end. Therefore, since there is no step on the inner peripheral surface 97 of the cylindrical portion 201, the second valve 36B can move smoothly in the front-rear direction.

In the ink cartridge 30, the lower support member 11 is in pressure contact with the press-fit surface 14 of the supply portion 33, and therefore the posture of the lower support member 11 is unlikely to be inclined. Therefore, the seal member 35 is in contact with the lower support member 11 so that the position of the seal member 35 is more accurately determined.

In the ink cartridge 30, the gap 18 of the lower support member 11 is in contact with the step surface 13 of the supply portion 33 in the rearward direction. Therefore, the position of the lower support member 11 is determine more accurately in the front-rear direction. Therefore, the seal member 35 whose position is determined by the lower support member 11 can easily be brought into contact with the transfer surface 116.

In the ink cartridge 30, the valve 36 contacts the seal member 35 at two positions, i.e., a position where the first valve 36A contacts the third protrusion 304 and a position where the second valve 36B contacts the rear end 111 of the rear portion 35B. Therefore, the ink in the ink cartridge 30 is unlikely to leak to the outside through the gap between the valve 36 and the seal member 35.

In the ink cartridge 30, when the supply tube 102 is connected to the supply port 34 and the rod 121 is connected to the atmosphere communication port 501, the ink in the ink cartridge 30 moves to the sub-tank 120 through the through hole 206, the internal space of the lower support member 11, and the internal space of the supply tube 102. At the same time, air flows into the ink cartridge 30 through the atmosphere communication port 501 and the inner space of the upper support member 38. Therefore, the ink in the ink cartridge 30 is likely to move to the sub-tank 120.

Since the upper valve mechanism 504 is provided in the ink cartridge 30 to open and close the atmosphere communication port 501, the ink in the ink cartridge 30 is less likely to leak to the outside through the atmosphere communication port 501.

In the ink cartridge 30, even when the container body 31 includes the second key portion 78 protruding upward from the third upper surface 83, the container body 31 including the second key portion 78 is easily formed integrally by blow molding. Therefore, the volume of the chamber 46 can be easily increased.

### Modification

In the ink cartridge 30, the outer peripheral surface 212A of the blow pin 212 is used as a mold for the transfer surface 116 when the container body 31 is blow-molded. However, the transfer surface 116 may be formed by transferring the shape of the outer peripheral surface of a mold different from the blow pin 212.

In the ink cartridge 30, the lower support member 11 is provided in the internal space of the supply portion 33. However, the lower support member 11 may be omitted. In this case, the valve 36 and the coil spring 37 may be supported by the inner peripheral surface 33A of the supply portion 33.

In the ink cartridge 30, the seal member 35 includes the front portion 35A and the rear portion 35B. However, the rear portion 35B may be omitted. In this case, the first valve 36A and the second valve 36B may be integrally formed as long as the through hole 19 of the seal member 35 can be opened and closed.

In the ink cartridge 30, the cap 39 is provided to be in contact with the seal member 35. However, the cap 39 may be omitted.

In the ink cartridge 30, the upper valve mechanism 504 is provided to open and close the atmosphere communication port 501. However, the upper valve mechanism 504 may be omitted. In this case, the atmosphere communication port 501 may be closed by a semipermeable membrane that blocks the passage of ink and allows the passage of air.

In the ink cartridge 30, the partition wall 205 that defines the through hole 206 is provided in the lower support member 11. However, the partition wall 205 may be omitted. In this case, the through hole 206 is defined by the rear end of the lower support member 11.

In the ink cartridge 30, the front portion 35A of the seal member 35 is in contact with the inner peripheral surface 33A of the supply portion 33. However, the front portion 35A of the seal member 35 may be in contact with the inner peripheral surface of the lower support member 11.

In the ink cartridge 30, the base 204 that supports the rear end of the second coil spring 37B is provided, but the base 204 may be omitted. In this case, the rear end of the second coil spring 37B may be supported by, for example, the front surface of the partition wall 205.

In the ink cartridge 30, the lower support member 11 is in pressure contact with the press-fit surface 14 of the supply portion 33. However, the lower support member 11 may not be in pressure contact with the inner peripheral surface 33A of the supply portion 33 as long as the lower support member 11 is prevented from being detached from the supply portion 33.

In the ink cartridge 30, the gap G1 between the lower surface of the outer peripheral surface of the reduced diameter portion 202 of the lower support member 11 and the press-fit surface 14 is smaller than the gap G2 between the upper surface of the outer peripheral surface of the reduced diameter portion 202 and the inner peripheral surface 33A of the supply portion 33, but may be the similar size to the gap G2. In this case, the press-fit surface 14 may not be inclined inward with respect to the front-rear direction.

In the ink cartridge 30, the length L1 of the upper support member 38 in the front-rear direction is greater than the length L2 of the lower support member 11 in the front-rear direction. However, the length L2 of the lower support member 11 in the front-rear direction may be equal to or less than the length L1 of the upper support member 38 in the front-rear direction. The upper support member 38 may be omitted.

In the ink cartridge 30, the rear end of the lower support member 11 is located rearward of the rear end of the upper support member 38 in the front-rear direction. However, the rear end of the lower support member 11 may be located at the same position as the rear end of the upper support member 38 in the front-rear direction, or may be located forward of the rear end of the upper support member 38 in the front-rear direction.

In the ink cartridge 30, the upper support member 38 includes the quadrangular tube 503B defining the quadrangular opening 515. However, the quadrangular tube 503B may be omitted. In this case, the rear end of the cylindrical body portion 503A may define a circular opening 515.

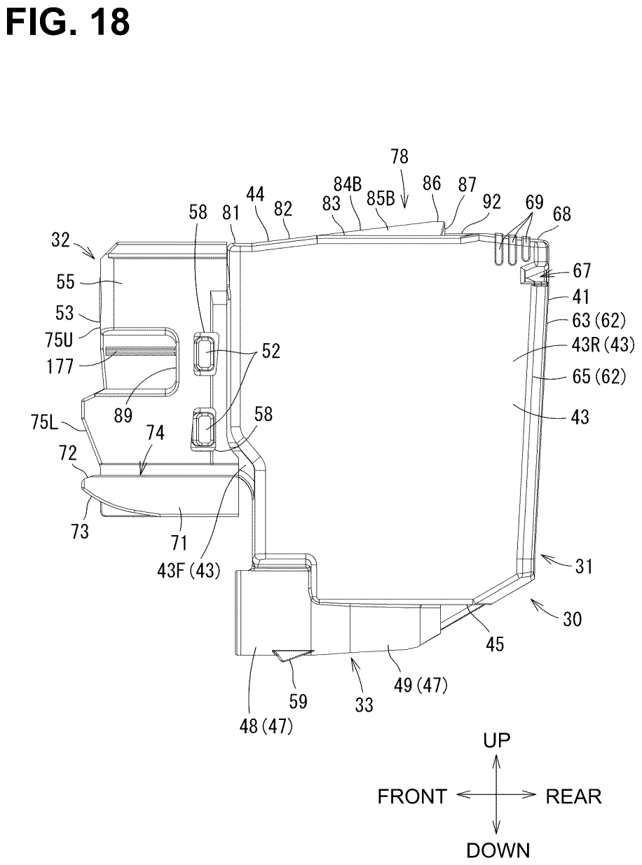

In the above-described embodiment, the first key portion 77 extends rearward from the lower surface 70 of the cover 32. Alternatively, as shown in FIG. 18, a first key portion 177 may protrude rightward from the right wall 55 of the cover 32 and extend along the front-rear direction. In this case, a groove extending in the front-rear direction into which the first key portion 177 enters is formed in the fitting piece 123 of the cartridge case 110. Alternatively, the first key portion 177 may protrude leftward from the left wall 54 of the cover 32 and extend along the front-rear direction. Further, the first key portion 177 may protrude in the left-right direction from one or both of the right wall 55 and the left wall 54 at positions other than the positions where the third key portion 79 is provided in the cover 32.

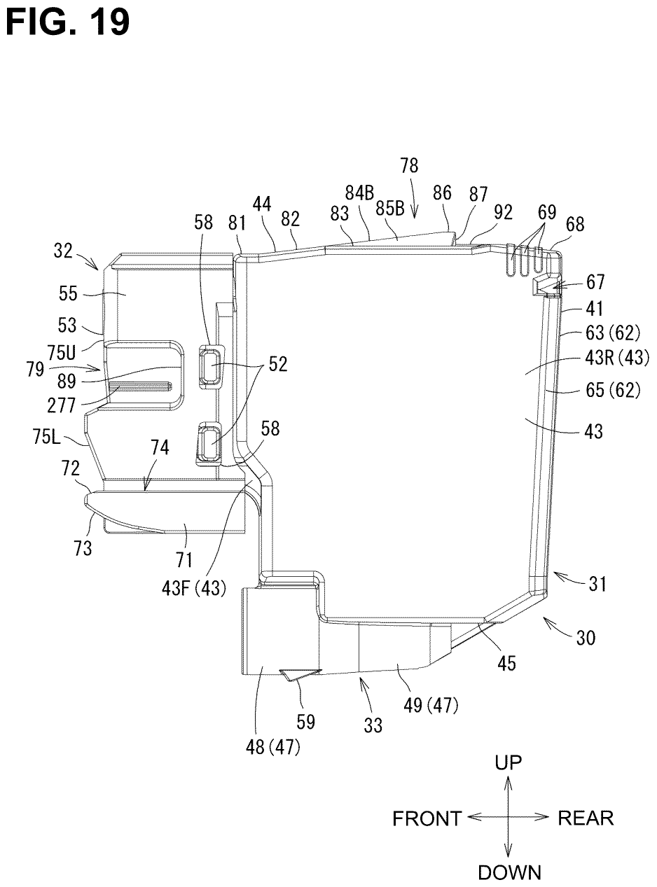

Further, as shown in FIG. 19, the first key portion 277 may be positioned in a recessed portion constituting the third key portion 79. Further, the rear end of the first key portion 277 may be separated from the rear end surface 89 of the recessed portion constituting the third key portion 79 in the front-rear direction. In the above-described embodiment, the first key portion 77 has a convex shape, and the first key slot 115 has a concave shape. However, the relationship between the mechanical characteristics of the first key portion 77 and the first key slot 111 may be reversed. Similarly, the shapes of the second key portion and the second receiving member may be reversed as explained for the first key portion and the first reception portion. In addition, the number of first key portions 277 is not limited to one, and may be two or more.

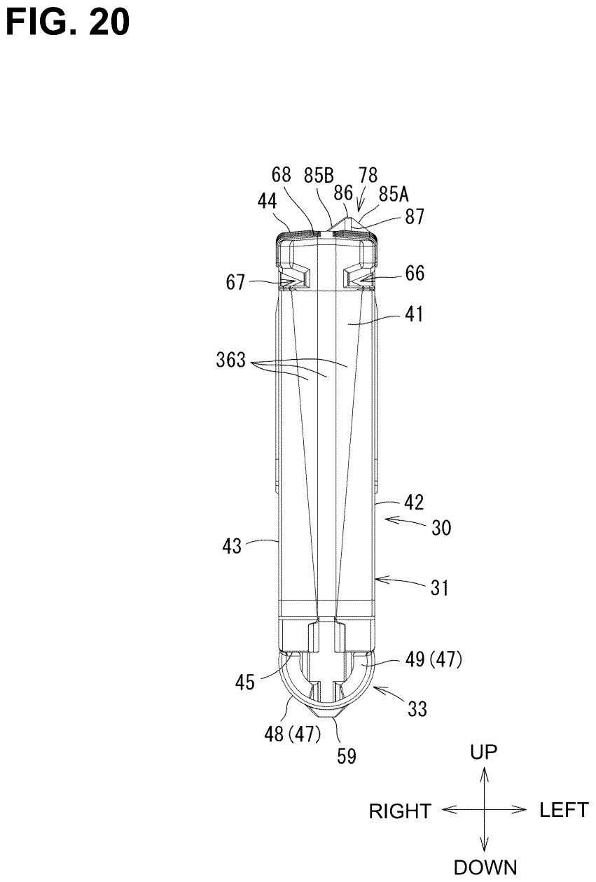

In the above-described embodiment, the length of the first rear surface 63 in the left-right direction is constant in the up-down direction. Alternatively, as shown in FIG. 20, the length of the first rear surface 363 in the left-right direction may gradually decrease toward the lower side in the up-down direction. This configuration can make it easier for the user to press the upper portion of the first rear surface 363, which is relatively wider than the lower portion of the first rear surface 363.

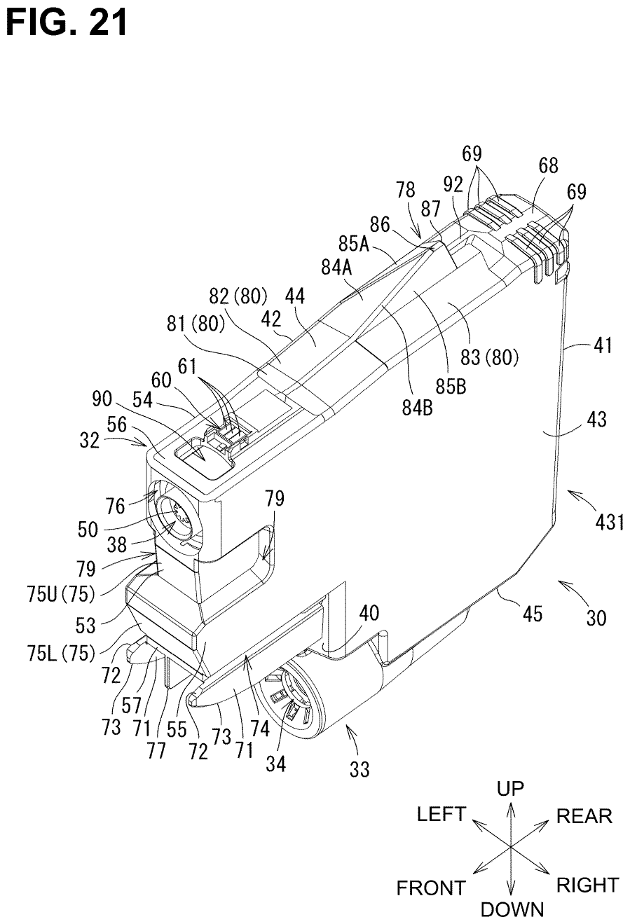

In the above-described embodiment, the ink cartridge 30 includes the container body 31 and the cover 32. Alternatively, as shown in FIG. 21, the ink cartridge 30 may have a container 431 in which the container body 31 and the cover 32 are integrally molded. In this case, the container 431 stores ink. The first key portion 77, the second key portion 78, and the IC board 60 are positioned in the container 431.

In the above-described embodiment, the atmosphere communication portion 502 is positioned on the upper front wall 40U of the container body 31, however the atmosphere communication portion 502 may be positioned on a wall other than the front wall 40 of the container body 31, for example, on the upper wall 44.

In the above-described embodiment, the pressing plate 134 and the ink receiving member 130 are arranged in the cartridge case 110. However, the pressing plate 134 and the ink receiving member 130 may also be omitted. In other words, the first key portion 77 may realize only the function of identifying the characteristic of the ink cartridge 30.

Further, the second key portion 78 may not have the locking surface 87. In other words, the second key unit 78 may realize only the function of identifying the characteristic of the ink cartridge 30.

In the above-described embodiment, the ink cartridge 30 is shown as an example of the liquid cartridge. However, the ink container may not be a cartridge attached to the printer 10, but may be a bottle for replenishing ink to a tank or the like of the printer.

What is claimed is:

1. A liquid cartridge comprising:
a housing that has a cylindrical portion; and
a first valve mechanism at least partially accommodated in the cylindrical portion, wherein
the housing is blow molded with air blown from an air nozzle,
at least a part of an inner surface of the cylindrical portion is a transfer surface to which an outer peripheral surface of a mold is transferred,
the first valve mechanism includes;
a seal member that defines a first through hole and is in contact with the transfer surface;
a valve positioned in the cylindrical portion and configured to open and close the first through hole; and
a biasing member configured to bias the valve toward the seal member, and
the seal member includes a first seal portion in contact with the transfer surface and a second seal portion configured to contact with the valve.

2. The liquid cartridge according to claim 1, wherein
the outer peripheral surface of the mold is an outer peripheral surface of the air nozzle.

3. The liquid cartridge according to claim 2, further comprising
a support member that has a cylindrical shape, is accommodated in the cylindrical portion, and accommodates the valve and the biasing member therein, wherein
the support member includes a contact portion in contact with the seal member.

4. The liquid cartridge according to claim 3, wherein
the cylindrical portion that extends in a first direction, and
the contact portion is in contact with the seal member in one direction in the first direction.

5. The liquid cartridge according to claim 4, wherein
the seal member includes:
a first portion having the first seal portion, and
a second portion having the second seal portion and extending form the first portion in an other direction opposite to the one direction.

6. The liquid cartridge according to claim 5, wherein
the first valve mechanism defines a second through hole and includes a contact member in contact with the seal member, and
the contact member is in contact with an inner peripheral surface of the first portion.

7. The liquid cartridge according to claim 4, wherein
the first valve mechanism defines a second through hole and includes a contact member in contact with the seal member.

8. The liquid cartridge according to claim 7, wherein
the contact member is in contact with the seal member in an other direction opposite to the one direction.

9. The liquid cartridge according to claim 8, wherein
the seal member has a first portion having the first seal portion, and
the contact member is in contact with an inner peripheral surface of the first portion.

10. The liquid cartridge according to claim 6, wherein
the contact member is bonded or welded to the transfer surface.

11. The liquid cartridge according to claim 3, wherein
at least a part of the inner peripheral surface of the support member is a first guide surface configured to guide the biasing member in a first direction in which the cylindrical portion extends.

12. The liquid cartridge according to claim 2, wherein
at least a part of the inner peripheral surface of the support member is a second guide surface configured to guide the valve in the first direction in which the cylindrical portion extends.

13. The liquid cartridge according to claim 12, wherein
the second guide surface is a single surface in the first direction.

14. The liquid cartridge according to claim 3, wherein
the support member is in pressure contact with at least a part of the inner surface of the cylindrical portion.

15. The liquid cartridge according to claim 14, wherein
the cylindrical portion has a tapered surface that defines an internal space such that the internal space gradually narrows in an other direction opposite to one direction in a first direction in which the cylindrical portion extends, and
the support member is in contact with the tapered surface.

16. The liquid cartridge according to claim 5, wherein
the valve includes a first valve configured to contact with the first portion and a second valve configured to contact with the second portion.

17. The liquid cartridge according to claim 1, wherein
the housing includes a chamber configured to store liquid therein and an atmosphere communication port configured to communicate with the chamber and an outside.

18. The liquid cartridge according to claim 17, wherein
the housing includes a semipermeable membrane that closes the atmosphere communication port, blocks passage of liquid, and allows passage of air.

19. The liquid cartridge according to claim 17, further comprising a second valve mechanism configured to open and close the atmosphere communication port.

20. The liquid cartridge according to claim 1, wherein
the housing includes a chamber configured to store liquid therein and a protrusion that protrudes from an outer surface of the housing, and
an internal space of the protrusion communicates with the chamber.

21. A manufacturing method for a liquid cartridge, the liquid cartridge including;
a housing that has a cylindrical portion; and
a first valve mechanism at least partially accommodated in the cylindrical portion, the manufacturing method comprising:
blow-molding the housing with air blown from an air nozzle, and in the blow-molding, at least a part of an inner surface of the cylindrical portion is a transfer surface to which an outer peripheral surface of a mold is transferred, and
inserting the first valve mechanism into the cylindrical portion, wherein
the first valve mechanism includes;
a seal member that defines a first through hole and is in contact with the transfer surface;
a valve positioned in the cylindrical portion and configured to open and close the first through hole; and
a biasing member configured to bias the valve toward the seal member, and
the seal member includes a first seal portion in contact with the transfer surface and a second seal portion configured to contact with the valve.
